(19) United States
(12) Patent Application Publication
(10) Pub. No.: US 2011/0042356 A1
(43) Pub. Date: Feb. 24, 2011

(54) ELECTRODE COATING APPARATUS AND METHOD

(76) Inventors: Cheuk H. LEUNG, Thornhill (CA); Nigel SCOTCHMER, Toronto (CA); Kevin R. CHAN, Brampton (CA)

Correspondence Address: OSTROLENK FABER GERB & SOFFEN, 1180 AVENUE OF THE AMERICAS, NEW YORK, NY, 100368403, US

(21) Appl. No.: 12/849,940

(22) Filed: Aug. 4, 2010

Related U.S. Application Data
(60) Provisional application No. 61/231,776, filed on Aug. 6, 2009.

(51) Int. Cl. C23C 26/00; B23K 9/04

(52) U.S. Cl. 219/76.13

(57) ABSTRACT

A coating deposition apparatus has first and second charge sources. The first charge source is chargeable to a first voltage potential and the second charge source is chargeable to a second voltage potential. The coating deposition apparatus also has a first output terminal and a deposition substance connected thereto, and a second output terminal for connection to a workpiece. The consumable deposition substance is movable relative to the workpiece. The first charge source is connected between the first and second terminals whereby the first voltage potential is established therebetween. The second charge source is connected between the terminals. The coating deposition apparatus also has discharge control circuitry connected to the first and second charge sources to inhibit discharge of the second charge source through the terminals prior to commencement of discharge of the first charge source through the terminals.

This application claims the benefit of U.S. Provisional Patent Application Ser. No. 61/231,776, entitled ELECTRODE COATING APPARATUS AND METHOD, filed Aug. 6, 2009, the entire contents and disclosure of which is incorporated by reference herein.

### FIELD OF THE INVENTION

This invention relates to the field of coating technologies, and more particularly, to an electrospark deposition coating apparatus and method.

### BACKGROUND OF THE INVENTION

Electrospark deposition (ESD) is a pulsed-arc micro-welding process that uses a short duration, high-current electrical pulse to melt and deposit a portion of a consumable electrode onto a workpiece. The deposited material alloys with the workpiece to form a metallurgical bond.

In the ESD process, the consumable electrode and the workpiece are connected to opposite terminals of a source of power or charge. When the consumable electrode and the workpiece are brought close together, the electric potential between the consumable electrode and the workpiece cause an electric spark. The spark generates an amount of heat, which melts a portion of the consumable electrode. The melted portion of the consumable electrode is then transferred from the consumable electrode and deposited locally on the workpiece in the region of the electric arc when the consumable electrode and the workpiece come into contact. The process may be repeated to form a coating on the workpiece.

One of the main advantages of the ESD process is that the consumable electrode material is fused to the workpiece at such low heat input that the workpiece remains at or neat ambient temperature. Specifically, by controlling the spark duration to a few microseconds and the spark frequency to around 1000 Hz, for example, the welding heat is generated during less than 1% of an ESD cycle, while the heat is dissipated during 99% or more of the cycle. Furthermore, the workpiece is constantly moving relative to the consumable electrode. Thus, the location of the electric arc, and the highly localized region of the workpiece subject to the heating, changes rapidly and, at the scale of interest, substantially randomly so a different region is being heated with each spark cycle. Therefore, unless the workpiece is particularly thin or the sparking time is unusually prolonged, the workpiece will remain near ambient temperature. In addition, since the deposited material is metallurgically bonded, it is inherently more resistant than the mechanically bonded coatings produced by other low-heat input processes, such as electro-chemical plating.

### SUMMARY OF THE INVENTION

In an aspect of the invention there is a coating deposition apparatus. It has first and second charge sources. The first charge source is chargeable to a first voltage potential and the second charge source is chargeable to a second voltage potential. The coating deposition apparatus also has a first output terminal and a deposition substance connected thereto, and a second output terminal for connection to a workpiece. The consumable deposition substance is movable relative to the workpiece. The first charge source is connected between the first and second terminals whereby the first voltage potential is established therebetween. The second charge source is connected between the terminals. The coating deposition apparatus also has discharge control circuitry connected to the first and second charge sources to inhibit discharge of the second charge source through the terminals prior to commencement of discharge of the first charge source through the terminals.

In another feature of that aspect of the invention, the discharge control circuitry includes at least one isolation element operable to prevent charge from flowing from the first charge source to the second charge source. In another feature of that aspect of the invention, the coating deposition apparatus has charging circuitry by which to charge the first and second charge sources. The discharge control circuitry is operable to inhibit discharge of at least one of the first and second charge sources during charging thereof. In another feature of that aspect of the invention, the coating deposition apparatus has voltage potential monitoring circuitry connected to sense voltage potential across the first charge source and across the second charge source. The discharge control circuitry is operable to inhibit discharge of the first and second charge sources until the first charge source reaches at least a first charging threshold voltage potential and the second charge source reaches at least a second threshold voltage potential.

In another feature of that aspect of the invention, at least one of the first and second charge sources is one of a) a capacitor; and b) a capacitor bank. In another feature, at least one of the first and second charge sources has a variable capacitance. In another feature of that aspect of the invention, the consumable deposition substance is composed at least in part of titanium, titanium carbide, titanium diboride, nickel, molybdenum, and tungsten. In another feature, the consumable deposition substance is predominantly titanium. In another feature, the workpiece is predominantly copper. In another feature of that aspect of the invention, the coating deposition apparatus has a vibrator mounted to act on at least one of (a) the workpiece; and (b) the consumable deposition substance. In another feature of that aspect of the invention, the coating deposition apparatus has a drive to spin at least one of (a) the workpiece; and (b) the consumable deposition substance, to present a different portion of the workpiece to the consumable deposition substance as a function of time.

In another aspect of the invention, there is a process of depositing a coating on an electrically conductive workpiece using a coating deposition apparatus. The coating deposition apparatus has first and second charge sources coupled between first and second output terminals. The process includes connecting a consumable deposition substance of coating material to the first terminal; connecting a workpiece to the second terminal; establishing a first voltage potential on the first charge source; establishing a second voltage potential on the second charge source; establishing the consumable deposition substance and the workpiece in close proximity; discharging charge from the first charge source between the consumable deposition substance and the workpiece, thereby melting some of the consumable deposition substance and depositing it on the workpiece; and after commencement of discharge of the first charge source, discharging charge from the second charge source between the consumable deposition substance and the workpiece, during arcing of current between the consumable deposition substance and the workpiece, thereby melting more of the consumable deposition substance and welding the melted consumable deposition substance to the workpiece.

In a feature of that aspect of the invention, the process includes monitoring the first voltage potential, and commencing discharge of the second charge source when the first voltage potential falls below a first threshold value. In another feature, the process includes recharging the first and second charge sources following respective discharge thereof, and inhibiting the recharging of at least the first charge source until the first voltage potential falls below a discharge threshold value. In another feature, the process includes re-charging the first and second charge sources, and during re-charging, inhibiting discharge of the first and second charge sources. In another feature, the first charge source has a first charging threshold voltage potential, the second charge source has a second charging threshold voltage potential, and during re-charging, the discharge is inhibited until the first charge source reaches at least the first charging threshold voltage potential and the second charge source reaches at least the second charging threshold voltage potential.

In a further feature, the first charging source provides a first total energy to the output terminals during discharge thereof. The second charging source provides a second total energy to the output terminals during discharge thereof. The first total energy is related to the first charging threshold voltage potential and the second total energy is related to the second charging threshold voltage potential. At least one of the first and second charging threshold voltage potentials is adjustable. In this feature the process includes adjusting the at least one charging threshold voltage potential.

In another feature, the first charge source is associated with a first capacitance and the second charge source is associated with a second capacitance. The first total energy is related to the first capacitance. The second total energy is related to the second capacitance. At least one of the first and second capacitances is adjustable. In this feature, the process includes adjusting the at least one capacitance. In another feature, the process includes waiting for a predetermined period of time following discharge and inhibiting discharge during the predetermined period of time. In another feature of that aspect of the invention, the process includes selecting the consumable deposition substance from amongst substances that are at least partially one of titanium, titanium carbide, titanium diboride, nickel, molybdenum, and tungsten. In another feature, the process includes selecting a substantially titanium substance as the consumable deposition substance. In another feature, the process includes selecting a copper substance as the workpiece. In another feature of that aspect of the invention, the process includes vibrating at least one of the consumable deposition substance and the workpiece. In another feature of that aspect of the invention, the process includes rotating at least one of the workpiece and the consumable deposition substance to present a different portion of the workpiece to the consumable deposition substance as a function of time.

### BRIEF DESCRIPTION OF THE DRAWINGS

These and other aspects of the invention may be more readily understood with the aid of the illustrative Figures included herein, and showing an example, or examples, embodying the various aspects and features of the invention which examples are provided by way of illustration, but not of limitation of the present invention, and in which:

FIGS. 1a and 1b are conceptual illustrations of the variation of the voltage and current during an ESD process;

FIG. 1c shows a graphical representation of overall output voltage as a function of time in an ESD process as described herein;

FIG. 1d is a graphical representation of voltage as a function of time for a first charge source of the ESD process of FIG. 1c;

FIG. 1e is a graphical representation of voltage as a function of time for a second charge source of the ESD process of FIG. 1c;

FIG. 2 is a block diagram of a system for transferring material from a consumable deposition substance to a workpiece in accordance with an aspect of the invention;

FIG. 3 is a block diagram of a coating deposition apparatus of the system of FIG. 2;

FIG. 4 is a circuit diagram of a first charge source of the coating deposition apparatus of FIG. 3;

FIG. 5 is a circuit diagram of a second charge source of the coating deposition apparatus of FIG. 3;

FIG. 6 is a circuit diagram of first charging circuitry of the coating deposition apparatus of FIG. 3;

FIG. 7 is a circuit diagram of second charging circuitry of the coating deposition apparatus of FIG. 3;

FIG. 8 is a circuit diagram of discharge circuitry of the coating deposition apparatus of FIG. 3;

FIG. 9 is a block diagram of a main control circuit of the coating deposition apparatus of FIG. 3;

FIG. 10 is a circuit diagram of a first input conditioning circuit of the coating deposition apparatus of FIG. 3;

FIG. 11 is a circuit diagram of a second input conditioning circuit of the coating deposition apparatus of FIG. 3;

FIG. 12 is a circuit diagram of a third input conditioning circuit of the coating deposition apparatus of FIG. 3;

FIG. 13 is a circuit diagram of an output signal conditioning circuit of the coating deposition apparatus of FIG. 3;

FIG. 14 is a circuit diagram of a first voltage comparison circuit of the main control circuit FIG. 9;

FIG. 15 is a circuit diagram of a second voltage comparison circuit of the main control circuit of FIG. 9;

FIG. 16 is a circuit diagram of a charging control circuit of the main control circuit FIG. 9;

FIG. 17 is a circuit diagram of a digital output isolation circuit of the main control circuit of FIG. 9; and

FIG. 18 is a block diagram of an alternative coating deposition apparatus of FIG. 2.

### DETAILED DESCRIPTION

The description that follows, and the embodiments described therein, are provided by way of illustration of an example or examples, of particular embodiments of the principles of the present invention. These examples are provided for the purpose of explanation, and not limitation, of those principles and of the invention. In the description, like parts are marked throughout the specification and the drawings with the same respective reference numerals. The drawings are not necessarily to scale and in some instances proportions may have been exaggerated in order more clearly to depict certain features of the invention.

Typically in electrospark deposition (ESD) processes, one terminal of a power source, or charge source, however it may be called, is connected to a consumable supply of deposition substance. The other terminal of the power source is connected to a workpiece on which an accretion of the deposition substance is desired. The consumable supply may have the form of an electrically conductive or semi-conductive rod of the deposition material. While the term “power source” may be used by persons of skill in the art, the “power source” may tend not to be a power source in the sense of a generator or supply of line power from electrical mains, but may rather tend to be a reservoir of electrical charge raised to some electrical potential that may then be permitted selectively to discharge through the various circuit elements. While this may be a power source, it is a transient source. This power source or charge source reservoir may itself be charged and recharged, as may be appropriate, by a “power source” in the sense, of a generator or a connection to a mains supply, whether direct or rectified, as may be. In the particular context of a releasable source of charge at an electrical potential, that charge source may often be a capacitor or a capacitor bank. In this document, unless otherwise noted or clear from a different context, the term “charge source” will be used to mean a power source that can be charged and discharged in a manner similar to a capacitor. For many purposes the terms power source and charge source may be used interchangeably herein. In some cases the predetermined threshold voltage to which the capacitor bank is to be charged is user adjustable. To add an additional measure of flexibility, the number of capacitors in the capacitor bank may also be varied.

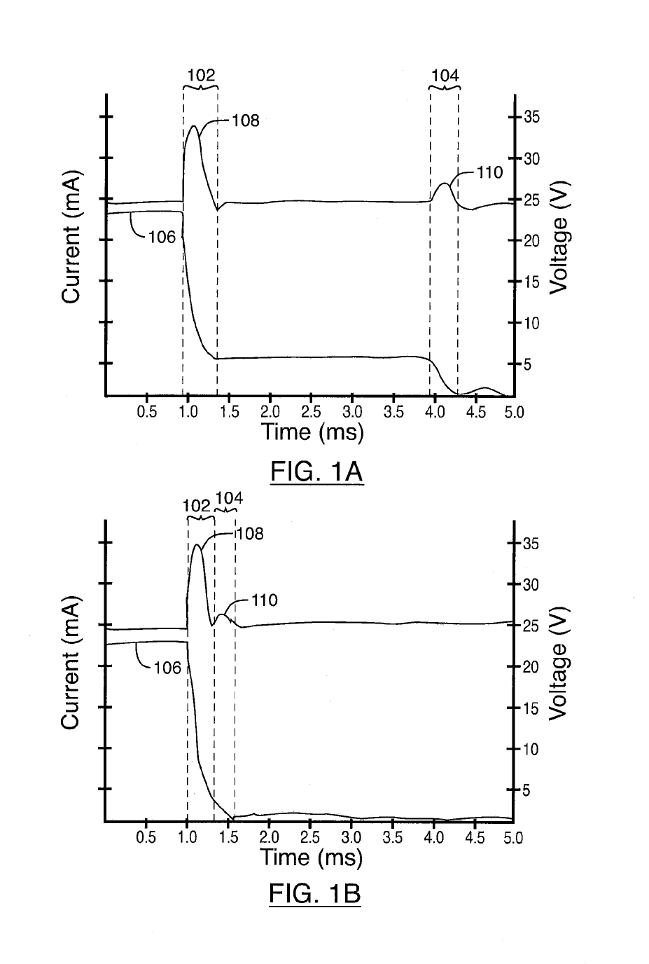

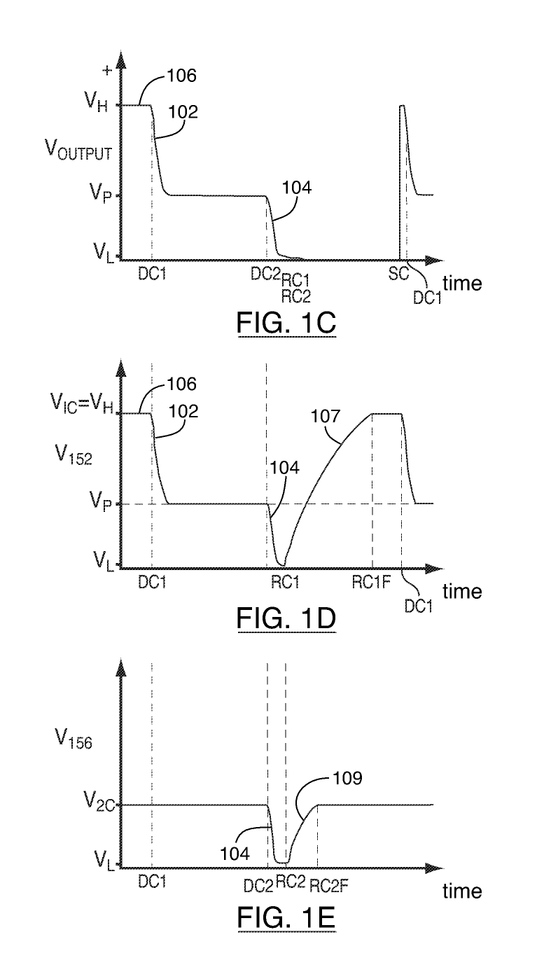

Once the charge source or power source has been charged to a predetermined voltage, the consumable deposition substance and the workpiece are brought into close proximity. Eventually an electric spark jumps the gap. Material from the consumable deposition substance melts and is transferred to the workpiece as current is drawn from the charge source. Up to now an assumption, or common understanding in the field, was that this transfer occurred in a single step. Specifically, it was thought that the current was drawn from the charge source in a single step (i.e. one current pulse). The inventors have observed, however, that the transfer tends to occur in two steps or phases which may have the form of two separate and distinct current pulses. Generally, the first phase is defined as the time period during which the first current pulse occurs, and the second phase is defined as the time period in which the second current pulse occurs. The first step, or phase, may be referred to as the sparking phase and the second step or phase may be referred to as the welding or arcing phase. The two phases and the associated current pulses are shown in FIG. 1a.

To begin the ESD process the charge source is charged to a predetermined voltage 106. The consumable deposition substance is then brought near the workpiece, triggering the first or sparking phase 102 at time t_{TD1}. That is, the difference in electric potential, V_{H}, between the consumable deposition substance and the workpiece causes an electric spark between the consumable deposition substance and the workpiece. A first electric current pulse 108 of relatively high amplitude then flows between the consumable deposition substance and the workpiece. As can be seen in FIGS. 1a, 1c and 1d, this causes a rapid drop in the charge source voltage to some level or plateau, V_{P}, that may be a modest value, and may approach zero volts. The heat generated in this sparking phase melts, and is thought partially to vaporize, a portion of the consumable deposition substance or a local portion of the workpiece, or both. This is believed to create a new narrow gap between the consumable deposition substance and the workpiece, and a consequent reduction in current flow.

As the consumable deposition substance continues to move towards the workpiece, the heated portion of the consumable deposition substance makes contact with the workpiece. It is at this point, identified as time t_{DC2}, that the second or arcing phase 104 occurs. A second electric current pulse 110 flows between the consumable deposition substance and the workpiece. Typically, the current flows until the charge source is substantially completely drained and a low threshold residual voltage level, V_{L}, is reached. The current flow produces additional heat that melts and fuses a portion of the consumable deposition substance to the workpiece, leaving an incremental accretion. The repeated additions eventually yield a coating covering, or substantially covering, the entire surface.

Generally, as shown in FIG. 1a, the respective commencements of the two discharge phases DC1 and DC2 (and thus the two current pulses) are separated in time. For example, in FIG. 1a, there is illustrated roughly a 2.5 ms delay between the first or sparking phase 102 and the second or arcing phase 104. Typically it is thought that the time between the two phases (and thus the time between the two current pulses) depends on the speed at which the consumable deposition substance and the workpiece are moved toward each other. If the consumable deposition substance and the workpiece are moved slowly toward each other, the two phases (and thus the two current pulses) may be quite clearly separate and may be separated by a substantial nil current plateau as shown in FIG. 1a. If however, the consumable deposition substance and the workpiece are moved together quickly, the two phases (and thus the two current pulses) may occur in quick succession, making it more difficult to distinguish the two phases (and thus the two pulses). An example of this is shown in FIG. 1b.

Known earlier ESD systems typically included only a single charge source. Embodiments herein, however, relate to ESD systems that have two independent charge sources connected to provide energy to the two distinct phases of the ESD process. That is, a first, higher voltage potential charge source may be used to provide energy in the form of a discharging electrical current to the sparking phase and a second, lower voltage potential charge source may be used to provide predominantly or entirely an additional charge, or boost, of energy also in the form of an electrical current, to the arcing phase. This may tend to allow at least a measure of independent control, or controlled variation, of the two phases of the ESD process, and thus an alteration or bias in the relative proportion of energy, and thus of heating, in the first and second pulses or pulse portions. In the view of the inventors this may tend to improve consistency of deposition. In the view of the inventors, a varied or independent control of this nature may tend to permit improvement of the coating quality, improvement of the energy efficiency of the coating process, or a decrease in the processing time to apply the coating, as compared to exiting single charge source systems (e.g. single capacitor or single capacitor bank systems). Of course, as may be determined by testing for a particular geometry or combination of materials, it may be desirable not to exceed a particular level of local heating in a single pulse cycle, as may be reflect the ability to cool the workpiece. To the extent that there is relative motion between the source of material and the surface to be coated, and there is a certain randomness in the location of the next deposition point due to that motion, such that the next burst or pulse of local heating will occur in a different location, and so on.

The systems described herein may be used, for example, for coating copper (Cu) or copper-based electrodes with titanium (Ti), titanium carbide (TiC), titanium diboride (TiB₂), nickel (Ni), tungsten (W), or molybdenum (Mb). However, the systems described herein may be used to coat other conductive workpieces with other suitable conductive materials.

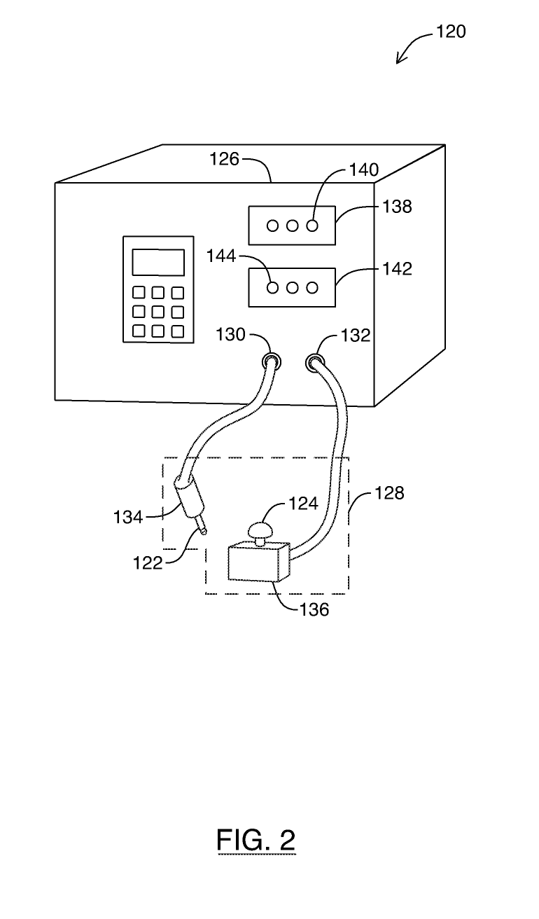

FIG. 2 shows an ESD system 120 for depositing material from a consumable deposition substance 122 on a workpiece 124. System 120 may include a coating deposition apparatus 126 and an ESD applicator assembly 128 operatively coupled to coating deposition apparatus 126.

Consumable deposition substance 122 and workpiece 124 are made of electrically conductive material, such as metals, alloys, conductive ceramics and cement. When consumable deposition substance 122 and workpiece 124 are set to different electric potentials an electric spark is generated between the two components as they are brought into sufficiently close proximity. As described above, the spark functions to melt a portion of consumable deposition substance 122 and to cause the transfer of the melted portion to workpiece 124. Consumable deposition substance 122 may, for example, be in the form of a consumable electrode or rod. Workpiece 124 may be in the form of an electrode, such as a copper or copper based welding electrode or cap or other substrate.

Coating deposition apparatus 126 may include a power source operable to provide the current needed for the ESD process; and a control circuit for controlling ESD applicator assembly 128. In some embodiments, the power source of coating deposition apparatus 126 may have first and second output terminals 130 and 132. For example, first and second output terminals 130 and 132 may be positive and negative terminals respectively. Coating deposition apparatus 126 may also include an input panel 138 comprising one or more input ports 140 for receiving input signals from one or more external devices. A description of suitable input signals will be provided below. Coating deposition apparatus 126 may also include an output panel 142 comprising one or more output ports 144 for outputting one or more output signals to one or more external devices. A description of suitable output signals will be provided below.

ESD applicator assembly 128 may include a consumable deposition substance holder 134, and a workpiece holder 136. Consumable deposition substance holder 134 may also be referred to as an applicator head or torch. Consumable deposition substance holder 134 and workpiece holder 136 are connected to opposite output terminals of the power source. For example, as shown in FIG. 2, consumable deposition substance holder 134 is connected to first terminal 130 and workpiece holder 136 is connected to second terminal 132. Typically consumable deposition substance holder 134 is connected to the positive output terminal, and workpiece holder 136 is connected to the negative output terminal. Voltage potential across terminals 130, 132 is identified as V_{Output}. This voltage potential may be taken as the potential between substance 122 and workpiece 124.

Consumable deposition substance holder 134 and workpiece holder 136 may each include, or be attached to, motors. The motors are typically used (i) to cause one of consumable deposition substance holder 134 (and incidentally the consumable deposition substance 122) and workpiece holder 136 (and incidentally workpiece 124) to vibrate; and (ii) to cause a least a portion of the other of the consumable deposition substance holder 134 and workpiece 136 to rotate. Typically, the consumable deposition substance holder is used to cause consumable deposition substance holder 134 (and incidentally consumable deposition substance 122) to vibrate; and the workpiece holder motor is used to rotate at least a portion of workpiece holder 136 (and incidentally workpiece 124).

In some embodiments, consumable deposition substance holder 134 and workpiece holder 136 may be moved manually towards and away from each other. For example, in one embodiment, an operator moves consumable deposition substance holder 134 toward and away from workpiece holder 136 to bring consumable deposition substance 122 and workpiece 124 into and out of contact. In other embodiments, consumable deposition substance holder 134 is connected to a machine that moves consumable deposition substance holder 134 toward and away from workpiece holder 136 to bring consumable deposition substance 122 and workpiece 124 into and out of contact.

Coating Deposition Apparatus

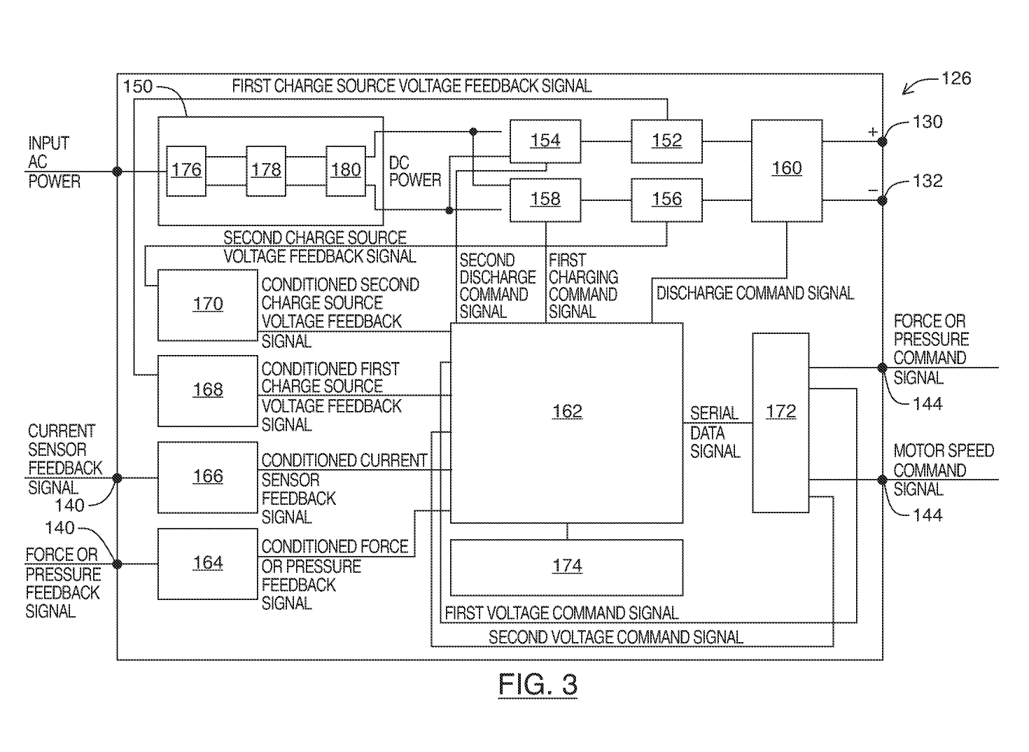

FIG. 3 shows coating deposition apparatus 126 of FIG. 2. Coating deposition apparatus 126 may include an input power circuit 150, a first power supply or first charge source 152, first charging circuitry 154, a second power supply or second charge source 156, second charging circuitry 158, discharge circuitry 160, a main control circuit 162, one or more input signal conditioning circuits 164, 166, 168 and 170, one or more output signal conditioning units 172, and a user interface 174. As noted above, in context, persons of skill in the art may also refer to first charge source 152, second charge source 156, and their related circuitry as first and second power sources.

Input power circuit 150 may receive AC (alternating current) power from a mains supply, for example, a standard 110V wall outlet, and converts it into stable DC (direct current) power suitable for ESD coating. The specific DC voltage required or selected as being suitable for the ESD coating process is based on the particular materials used for consumable deposition substance 122 and workpiece 124, and may reflect previous experience or testing, or both. This voltage may be designated as the high level or initial high threshold voltage, V_{H}. For example, in one embodiment a DC voltage of V_{H} of around 32Vdc has been found to be suitable, as, for example, for coating copper alloy electrodes with titanium carbide (TiC). Other voltage levels might be used in the range of about 24Vdc to about 50Vdc, or more narrowly about 30Vdc to about 36Vdc.

Input power circuit 150 may include an input transformer 176, a rectifier 178 and a main power supply charge source 180. Input transformer 176 receives the input AC signal and steps it down or reduces it to a suitable AC signal. For example, input transformer 176 may receive a 110Vac signal, which it steps down to a 48Vac signal. Rectifier 178 may provide full-wave rectification of the reduced AC signal to produce a DC output signal. For example, rectifier 178 may receive a 48Vac signal and convert it to a 68Vdc signal. Rectifier 178 may be configured to convert the AC voltage signal received from input transformer 176 to any suitable DC voltage. For example, rectifier 178 may convert the AC voltage signal to a 150Vdc signal or a 250Vdc signal. The DC signal output by rectifier 178 is used to charge main charge source 180. The energy stored in main charge source 180 is used to charge first and second charge sources 152 and 156 through first and second charging circuitry 154 and 158.

Main charge source 180 may be a capacitor bank made up of a plurality of capacitors connected in parallel. The capacitors may each have the same capacitance; however, they may also have different capacitances. In one embodiment, main charge source 180 may include a number of 1200 μF/120V capacitors connected in parallel. In one embodiment there may be eight such capacitors. The total capacitance of main charge source 180 may be in the range of 12,000 μF to 30,000 μF and in one embodiment may be about 17,600 μF.

Conceptually, main charge source 180 functions as a large holding tank, or reservoir of charge for replenishing the first and second charge sources 152, 156 as may be. This recharging is inhibited, i.e., the charging circuit is disabled, during the discharging period of the operational or duty cycle of charge sources 152, 156, and enabled during the recharging portion of the cycle.

Input power circuit 150 may also include a bleeding resistor (not shown) and relay (not shown) connected in series with each other, and in parallel with main charge source 180. The bleeding resistor is used slowly to discharge energy stored in main charge source 180 when power is removed from input power circuit 150. The relay is typically enabled when power is applied to input transformer 176 which disconnects the resistor from the remainder of the input power circuit 150. Conversely, the relay is typically disabled when power is removed from input power circuit 150 which connects the resistor to the input power circuit 150.

First charge source 152, also referred to as the sparking charge source, is used to supply energy in the form of electrical current to the sparking phase of the ESD process. The voltage potential of charge source 152 is identified as V₁₅₂. First charge source 152 may be a single capacitor, or a capacitor bank that includes a plurality of capacitors connected in parallel. First charging circuitry 154 charges first charge source 152 to establish a first voltage potential on first charge source 152. This initial potential is the high threshold voltage, V_{H}. First charge source 152 is subsequently discharged by discharge circuitry 160 to provide energy to the sparking phase of the ESD process.

The total energy available to be supplied by first charge source 152 is represented by equation (1) where C is the capacitance of first charge source 152, and V is the first voltage potential of first charge source 152 at the time the discharge commences.

$$E = \frac{1}{2} {CV}^{ 2} \qquad ( 1 )$$

In some embodiments, first charge source 152 is charged to a first charging threshold voltage potential V_{1C} prior to being discharged by discharge circuitry 160. Typically, V_{1C}=V_{H}. The first charging threshold voltage V_{1C} potential may be user adjustable. For example, user interface 174 may allow the user to input or select the first charging threshold voltage potential V_{1C}. In some embodiments, user interface 174 allows the user to select a first charging threshold voltage potential between 15Vdc and 50Vdc. The default value may be, for example, 30Vdc or thereabout. In other embodiments, user interface 174 allows the user to select a first charging threshold voltage potential up to 150Vdc or 250Vdc. For a given size of capacitor or capacitor bank the first charging threshold voltage potential V_{1C} determines the amount of heat generated during the ESD process. Typically, the greater the first charging threshold voltage potential V_{1C}, the greater the heat generated during the sparking phase.

In some embodiments, the capacitance of first power supply or charge source 152 is fixed. For example, first charge source 152 may have a fixed capacitance of 2000 μF, formed by two 1000 μF capacitors connected in parallel. In other embodiments, the total capacitance of first charge source 152 is adjustable. For example, user interface 174 may allow the operator to select a capacitance value. Relay circuits or selector switches may then be used to control the number of capacitors in first charge source 152.

The capacitance of first charge source 152 and the first charging threshold voltage potential required for the ESD process are based on the specific materials used for consumable deposition substance 122 and workpiece 124.

First charging circuitry 154 receives DC power from input power circuit 150 and charges first charge source 152 to establish a first voltage potential V_{H} on first charge source 152. This charging or re-charging is indicated as 107 in FIG. 1d, for example. In some embodiments, first charging circuitry 154 is controlled by a first charging command signal generated by main control circuit 162. For example, the first charging command signal may enable or disable first charging circuitry 154 when certain conditions are met. In some cases, first charging circuitry 154 (and incidentally charging of first charge source 152) may not be enabled, as a time RC1 (or, t_{RC1}) until main control circuit 162 detects that the second or arcing phase of the ESD process has occurred. Main control circuit 162, may, for example, detect that the second or arcing phase of the ESD process has occurred when the voltage potential of one or both of first and second charge sources 152 and 156 have dropped below a discharge low threshold value, V_{L}. In some embodiments, the discharge threshold value of V_{L} is zero or substantially zero.

Second charge source 156, also referred to as the arcing charge source, is used to provide a supplemental source of electrical current, or power, or energy to the arcing phase of the ESD process. Instantaneous voltage at any time t for second charge source 156 may be identified as V₁₅₆. Second charge source 156 may be a single capacitor, or a capacitor bank that includes a plurality of capacitors connected in parallel. Second charging circuitry 158 charges second charge source 156 to establish a second voltage potential on second charge source 156. Second charge source 156 is subsequently discharged by discharge circuitry 160 to provide a supplemental source of energy to the arcing phase of the ESD process. The total energy supplied by second charge source 156 is represented by equation (1) where C is the capacitance of second charge source 156, and V is the second voltage potential of second charge source 156 at the time the discharge commences.

In some embodiments, second charging source 156 is charged to a second charging threshold voltage potential V_{2C} prior to being discharged by discharge circuitry 160. Typically the second charging threshold voltage potential V_{2C} is less than the first charging threshold voltage potential so that second charge source 156 is charged to a lower voltage potential than first charge source 152. It may also be lower than the plateau voltage, V_{P}. In some embodiments, the second charging threshold voltage potential is user adjustable. For example, user interface 174 may allow the operator to input or select the second charging threshold voltage potential. In some embodiments, user interface 174 allows the operator to select a second charging threshold voltage potential between 10Vdc and 50Vdc. The default value may be, for example, 10Vdc.

In some embodiments, the capacitance of second charge source 156 is fixed. For example, second charge source 156 may have a fixed capacitance of 880 μF, formed by four 220 μF capacitors connected in parallel. In other embodiments, the capacitance of second charge source 156 is user adjustable. For example, user interface 174 may allow the operator to select a capacitance value for second charge source 156. Relay circuits or selector switches may then be used to control the number of capacitors in second charge source 156.

The capacitance of second charge source 156 and the second charging threshold voltage potential required for the ESD process are based on the specific materials used for consumable deposition substance 122 and workpiece 124.

Second charging circuitry 158 receives DC power from input power circuit 150 and charges second charge source 156 to establish a second voltage potential V₁₅₆ on second charge source 156. This recharging is identified at 109 in FIG. 1e. In some embodiments second charging circuitry 158 is controlled by a second charging command signal generated by main control circuit 162. For example, the second charging command signal may only enable second charging circuitry 158 (and incidentally charging of second charge source 156) when certain conditions are met. In some cases, second charging circuitry 158 may only be enabled, as at time RC2, after main control circuit 162 detects that the second or arcing phase of the ESD process has occurred. Main control circuit 162, may, for example, detect that the second or arcing phase of the ESD process has occurred when the voltage potentials of one or both of first and second charge sources 152 and 156 have fallen below a discharge threshold value. In some embodiments, the discharge low threshold value V_{L} is zero or substantially zero.

Discharge circuitry 160 controls discharge of first and second charge sources 152 and 156. When discharge circuitry 160 is enabled as at time SC such that the voltage potential of V₁₅₂ appears across the output terminals 130, 132. First and second charge sources 152 and 156 may be discharged and thus provide power to the ESD process at the next following opportunity (FIG. 1c). Conversely, when discharge circuitry 160 is disabled, first and second charge sources 152 and 156 are inhibited from being discharged, and thus no power may be provided to the ESD process.

Discharge circuitry 160 is typically controlled by a discharge command signal generated by main control circuit 162. In some embodiments, discharge circuitry 160 is disabled (and discharge of first and second charge sources 152 and 156 is inhibited) until the main control circuit 162 detects that first and second charge sources 152 and 156 have been charged to the first and second charging threshold voltage potentials V_{1C} and V_{2C}, the charging being completed, or finishing, at times RC1F and RC2F respectively. When the controller senses that both V₁₅₂=V_{1C} and V₁₅₆=V_{2C}, further charging may be inhibited, and the appropriate switch set, as at time SC to enable the next discharge. The full cycle between on discharge and the next discharge may typically be of the order of something less than a millisecond, such as perhaps 400-500 microseconds (+/−).

When discharge circuitry 160 is enabled, first and second charge sources 152 and 156 may be discharged. During sparking phase 102 of the ESD process, the electric spark draws energy from the charge source with the higher voltage potential (typically first charge source 152). As charge is drawn from the higher voltage potential charge source, that voltage potential drops below a minimum sparking threshold voltage at which the spark can be maintained. The minimum sparking threshold voltage is somewhat higher than, but relatively close to V_{P}, such that V_{P} may be considered a fair approximate of the minimum sparking threshold voltage. In one embodiment this minimum sparking threshold voltage, i.e. approximately V_{P}, may be in the range of about 10 to 16 Vdc. During arcing phase 104 energy is drawn from both charge sources 152 and 156 until they are substantially drained. Accordingly, in arcing phase 104, the lower voltage potential charge source (typically second charge source 156) can be described as boosting the current flow.

To the extent that V_{P} is established on the basis of previous testing, V_{2C} can be selected as a lower value. This value may be, typically, from about ¼ or ⅓ to about ⅖ or ½ of V_{H}. The size of second charge source 156 may then be selected to alter the proportion of the total charge or energy pulse that occurs in the second stage or phase, making it larger than it might otherwise be such that a greater than normal proportion of the heating, and therefore melting and deposition occurs during the arcing or welding phase. This in turn may cause a greater amount of welded coating to be deposited during this phase.

Main control circuit 162 receives one or more internal and external input signals, and produces one or more internal and external output signals based on the input signals. An internal input signal is defined as a signal generated by a component of coating deposition apparatus 126. Conversely, an external input signal is defined a signal generated by a component external to coating deposition apparatus 126. The external input signals may be received via input panel 138 and input ports 140, and the external output signals may be output via output panel 142 and output ports 144. Main control circuit 162 may receive, for example, the following analog input signals: a force or pressure feedback signal, a current sensor feedback signal, a first charge source voltage feedback signal, and a second charge source voltage feedback signal.

The force or pressure feedback signal is a measure of the force or pressure applied at the contact interface between consumable deposition substance 122 and workpiece 124 when consumable deposition substance 122 and workpiece 124 come into contact during the ESD process. In some embodiments, the pressure is measured by using a load cell. However, the pressure may be measured by any other direct or indirect means.

The current sensor feedback signal is a measure of the current flowing between consumable deposition substance 122 and workpiece 124. In some embodiments, the current is measured by a hall effect sensor. However, the current may be measured by any other direct or indirect means.

The first charge source voltage feedback signal is a measure of the first voltage potential V₁₅₂ of first charge source 152, and the second charge source voltage feedback signal is a measure of the second voltage potential V₁₅₆ of second charge source 156.

Typically the input signals are “conditioned” by conditioning circuits 164, 166, 168 and 170 prior to being processed by main control circuit 162.

Main control circuit 162 may generate the following digital output signals: the first charging command signal, the second charging command signal, and the discharge command signal. As described above, the first charging command signal controls first charging circuitry 154 and thus the charging of first charge source 152, and the second charging command signal controls second charging circuitry 158 and thus the charging of second charge source 156. In some embodiments, the first and second charging command signals are pulse width modulation (PWM) signals that are only enabled after main control circuit 162 has determined that the ESD process is complete. Specifically, the first and second charging command signals may be triggered after both the spark and arcing phases of the ESD process are complete. Main control circuit 162 may determine, for example, that the ESD process is complete when the voltages of both first and second charge sources 152 and 156 dip below a discharge threshold level V_{L}. In some embodiments, the discharge threshold level V_{L} may be zero or substantially zero.

As described above, the discharge command signal enables discharge circuitry 160, allowing first and second charge sources 152 and 156 to be discharged during the ESD process. In some embodiments, main control circuit 162 may enable discharge circuitry 160 only after first and second charge sources 152 and 156 have been charged to the first and second charging threshold voltage potentials respectively; and may disable discharge circuitry 160 only after the ESD process is complete (e.g. after the voltages of first and second charge sources 152 and 156 drop to below the discharge threshold level V_{L} (e.g. zero or substantially zero).

Main control circuit 162 may also generate the following analog output signals: a first voltage command signal, a second voltage command signal, a motor speed command signal and a force or pressure command signal. In some embodiments, as shown in FIG. 2, the analog output signals are output as a single serial data signal. The serial data signal is then processed by output signal conditioning circuit 172 to generate the individual analog output signals. In other embodiments, the output signal conditioning circuitry is built into main control circuit 162 so that main control circuit 162 outputs the individual analog output signals directly.

The first voltage command signal represents the first charging threshold voltage potential (i.e. the sparking voltage), and the second voltage command signal represents the second charging threshold voltage potential (i.e. the arcing voltage). As described above, in some embodiments, the first and second charging threshold voltage potentials may be set by an operator via user interface 174.

The motor speed command signal is used to control the motor speed of one or both of the consumable deposition substance holder 134 motor and the workpiece holder 136 motor. For example, the motor speed command signal may control the frequency, or frequency and amplitude of vibration of consumable deposition substance holder 134, or the speed of rotation of workpiece holder 136, or both. In some embodiments, the motor speed is user adjustable. For example, user interface 174 may allow the operator to set a motor speed parameter that is translated into a motor speed voltage by main control circuit 162. In one embodiment, the operator may set the motor speed parameter to a value between 0 and 100% with 100% being translated into the maximum motor speed voltage. The default motor speed parameter may be 50%.

The force or pressure command signal is used to control the pressure or force at which consumable deposition substance 122 is brought into contact with workpiece 124 when consumable deposition substance holder 134 is controlled by a machine rather than by an operator. The force or pressure command signal is designed to interface with a pressure actuator circuit of the machine. In some embodiments, the pressure or force is user adjustable. For example, user interface 174 may allow the operator to set a pressure or force parameter that is translated into a pressure or force voltage level by main control circuit 162. In one specific embodiment, the operator may set the pressure parameter to a value between 0 and 100% with 100% being translated into a set maximum force or pressure voltage. The default pressure parameter may be 50%.

There is typically one input signal conditioning circuit 164, 166, 168, 170 for each of the analog input signals received by main control circuit 162. The purpose of each signal conditioning unit is to: (i) convert the input signal into a format that main control circuit 162 can process; and (ii) isolate main control circuit 162 from the internal or external source of the input signal. For example, in some embodiments, main control circuit 162 converts each analog input signal into a corresponding digital signal using a 2.5V reference voltage. Accordingly, main control circuit 162 can only accurately process analog signals with a range of 0V to 2.5V. Accordingly, the conditioning circuits must convert the input analog signals to be within a range of 0V to 2.5V.

As described above, in some embodiments, main control circuit 162 receives the following four analog input signals: a pressure feedback signal, a current sensor feedback signal, a first charge source voltage feedback signal and a second charge source voltage feedback signal. Accordingly, in these embodiments, there are four conditioning circuits 164, 166, 168 and 170. First input conditioning circuit 164 conditions the force or pressure feedback signal; second input conditioning circuit 166 conditions the current sensor feedback signal; third input conditioning circuit 168 conditions the first charge source voltage feedback signal; and fourth input conditioning circuit 170 conditions the second charge source voltage feedback signal. Fourth input conditioning circuit 170 is typically similar to, or identical to, third input conditioning circuit 168.

Output signal conditioning circuit 172 is used when main control circuit 162 outputs the first voltage command signal, the second voltage command signal, the pressure command signal and the motor command signal as a single digital serial data signal. In these cases, output signal conditioning circuit 172 converts the serial data signal into the individual analog signals and up-converts or down-converts the signals as required. In some embodiments, the output signal conditioning circuit includes a plurality of digital to analog converters to convert the serial data signal into analog signals. In one particular embodiment, the analog to digital converts will use a reference voltage of 2.5V which will produce analog output signals with a range of 0 to 2.5V. Where other formats or levels (e.g. 0-10V, 4-20 mA) are required, output signal conditioning circuit 172 may also include converter or driver circuits.

User interface 174 may allow the operator to adjust certain operating parameters or to view diagnostic and operating parameter information, or both. For example, as described above, user interface 174 may allow the operator to adjust and view: the capacitance of first charge source 152; the first charging threshold voltage potential associated with first charge source 152; the capacitance of second charge source 156; the second charging threshold voltage potential associated with second charge source 156; the force or pressure; and the motor speed. User interface 174 is typically communicatively coupled to main control circuit 162 so that any operator-initiated changes to the operating parameters may be communicated to main control circuit 162.

In some embodiments, user interface 174 is a display and keypad unit comprising a display and a keypad. The display may be a basic LCD display, such as the Matrix Orbital™ LK122-25 intelligent LCD display. The LK122-25 provides two lines by twenty character alphanumeric LCD display, with a backlight. The keypad may be a basic numeric keypad, such as Grayhill' S™ simple 4×4 button keypad. In these embodiments, user interface 174 may be connected to the main processor by an RS232 communications port.

Charge Source Circuit

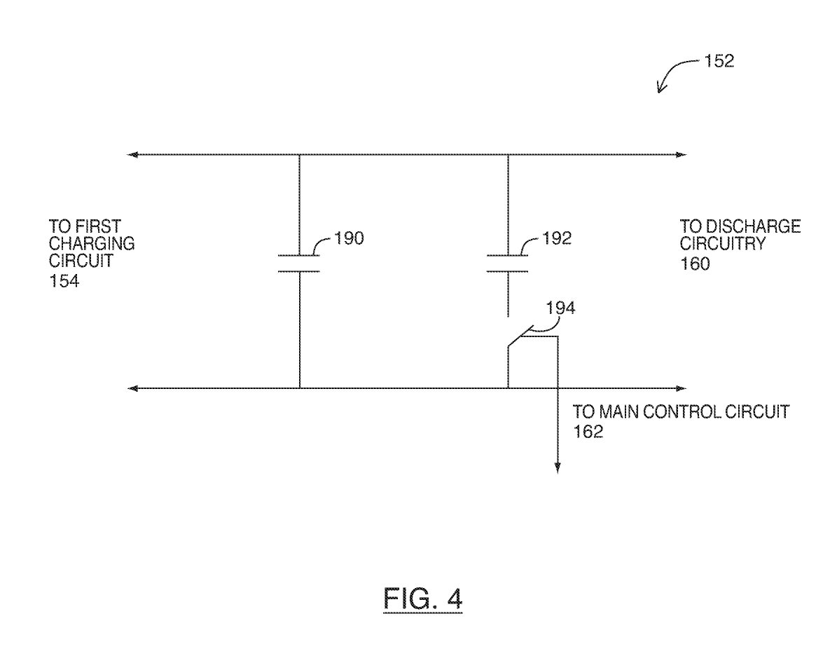

FIG. 4 shows first charge source 152 of FIG. 3. As described above, first charge source 152 is used to supply energy to the sparking phase of the ESD process. In one embodiment, first charge source 152 is a capacitor bank with two capacitors 190 and 192 connected in parallel. Where capacitors are connected in parallel the total capacitance is the sum of the individual capacitances. In one embodiment, the capacitance of both first and second capacitors 190 and 192 is 1000 μF, thus the total capacitance of first charge source 152 is 2000 μF. The total capacitance of first charge source 152 required for the ESD process is based on the specific materials used for consumable deposition substance 122 and workpiece 124.

In some embodiments, the number of capacitors (e.g. first and second capacitors 190 and 192) forming first charge source 152 is adjustable. For example, first charge source 152 may include one or more switches, such as switch 194, for selecting or deselecting certain capacitors (i.e. second capacitor 192). Typically each switch (i.e. switch 194) is in series with a single capacitor and is activated or deactivated by main control circuit 162. In some cases the number of capacitors forming first charge source 152 is user selectable. For example, the user may be able to select the capacitance of first charge source 152 via user interface 174.

In operation, capacitors 190 and 192 are charged by first charging circuitry 154 to establish a first voltage potential in capacitors 190 and 192. Capacitors 190 and 192 are subsequently discharged through discharge circuitry 160 to provide energy to the sparking phase of the ESD process. In some embodiments, discharge circuitry 160 is only enabled after capacitors 190 and 192 have been charged to the first charging threshold voltage potential V_{1C}.

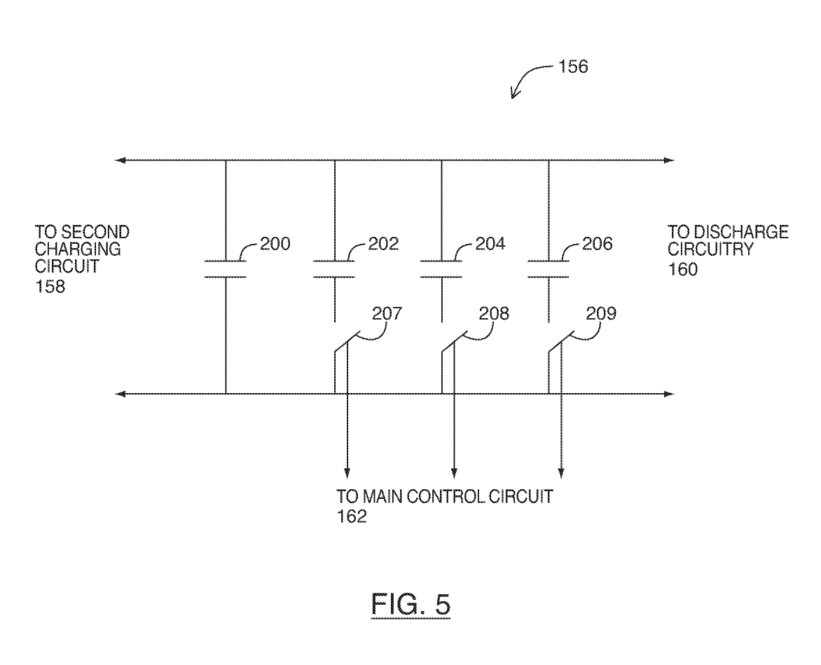

FIG. 5 shows second charge source 156 of FIG. 3. As described above, second charge source 156 is used to provide supplemental energy to the arcing phase of the ESD process. In one embodiment, second charge source 152 is a capacitor bank with four capacitors 200, 202, 204, and 206 connected in parallel. Where capacitors are connected in parallel the total capacitance is the sum of the individual capacitances. In one embodiment, the capacitance of all four capacitors 200, 202, 204 and 206 is 220 μF, thus the total capacitance of second charge source 156 is 880 μF. The total capacitance of second charge source 156 required for the ESD process is based on the specific materials used for consumable deposition substance 122 and workpiece 124.

In some embodiments, the number of capacitors (e.g. first, second, third and fourth capacitors 200, 202, 204 and 206) forming second charge source 156 is adjustable. For example, second charge source 156 may include one or more switches, such as switches 207, 208 and 209, for selecting or deselecting certain capacitors (i.e. second, third, or fourth capacitors 202, 204 and 206). Typically each switch (i.e. switches 207, 208 and 209) is in series with a single capacitor and is activated or deactivated by main control circuit 162. In some cases the number of capacitors forming second charge source 156 is user selectable. For example, the user may be able to select the capacitance of second charge source 156 via user interface 174.

In operation, capacitors 200, 202, 204 and 206 are charged by second charging circuitry 158 to establish a second voltage potential in capacitors 200, 202, 204 and 206. Capacitors 200, 202, 204 and 206 are subsequently discharged by discharge circuitry 160 to provide supplemental energy to the sparking phase of the ESD process. In some embodiments, discharge circuitry 160 is only enabled after capacitors 200, 202, 204 and 206 have been charged to the second charging threshold voltage potential V_{2C}.

Charging Circuitry

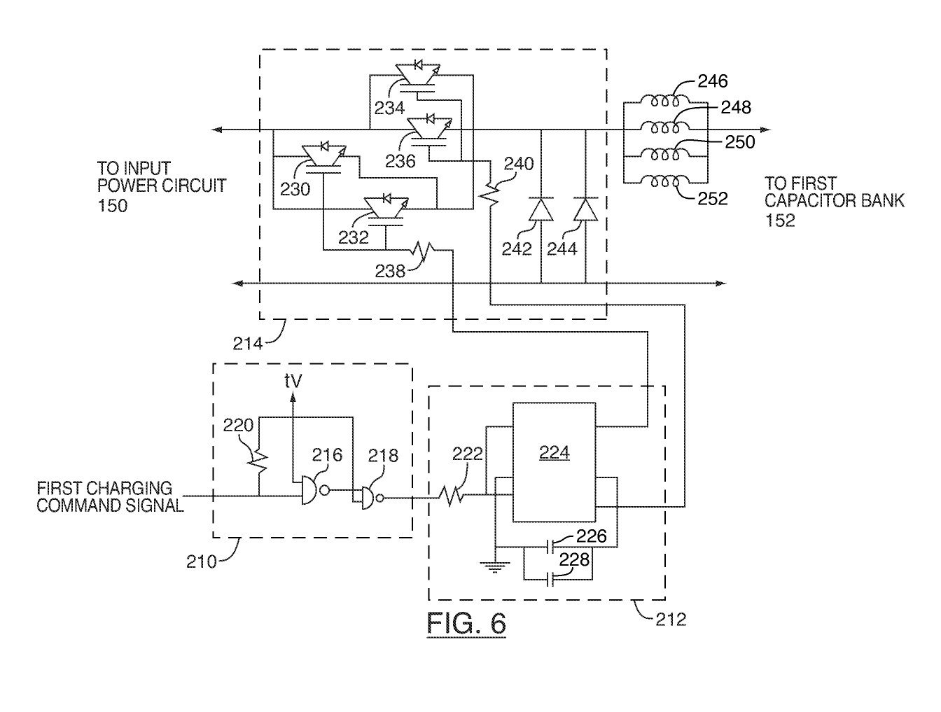

FIG. 6 shows first charging circuitry 154 of FIG. 3. As described above, first charging circuitry 154 receives DC power from input power circuit 150 and charges first charge source 152 to establish a first voltage potential on first charge source 152. First charging circuitry 154 may include a level shifter circuit 210, a gate driver circuit 212, and a current supply circuit 214.

Level shifter circuit 210 receives the first charging command signal from main control circuit 162 and converts it to an appropriate level for gate driver circuit 212. Level shifter circuit 210 may include two NOR gates 216 and 218 connected in series and a resistor 220 connected to the first input of first NOR gate 216. NOR gates 216 and 218 may be 4093N NOR gates.

Gate driver circuit 212 receives the control signal from level shifter circuit 210 and provides sufficient current to drive current supply circuit 214. Gate driver circuit 212 may include a resistor 222, a gate driver integrated circuit (IC) chip 224 and two capacitors 226 and 228. Gate driver IC chip 224 may be a TC1234 dedicated MOSFET/IGBT gate driver.

Current supply circuit 214 receives DC power from input power circuit 150 and, when enabled, produces a charging current from the DC power. The charging current is then supplied to first charge source 152 to establish a first voltage potential on first charge source 152. Current supply circuit 214 is enabled by gate driver circuit 212. Current supply circuit 214 may include four transistors 230, 232, 234, 236, two resistors 238 and 240, two diodes 242 and 244, and four inductors 246, 248, 250 and 252. Transistors 230, 232, 234 and 236 are connected in parallel to provide a large charging current to first charge source 152. Inductors 246, 248, 250 and 252 are connected in parallel to support the charging current provided by the transistors. Transistors 230, 232, 234 and 236 may be insulated gate bipolar transistors (IGBT) on FGA180N30 chips, and diodes 242 and 244 may be RURG3440 ultra-fast soft-recovery diodes.

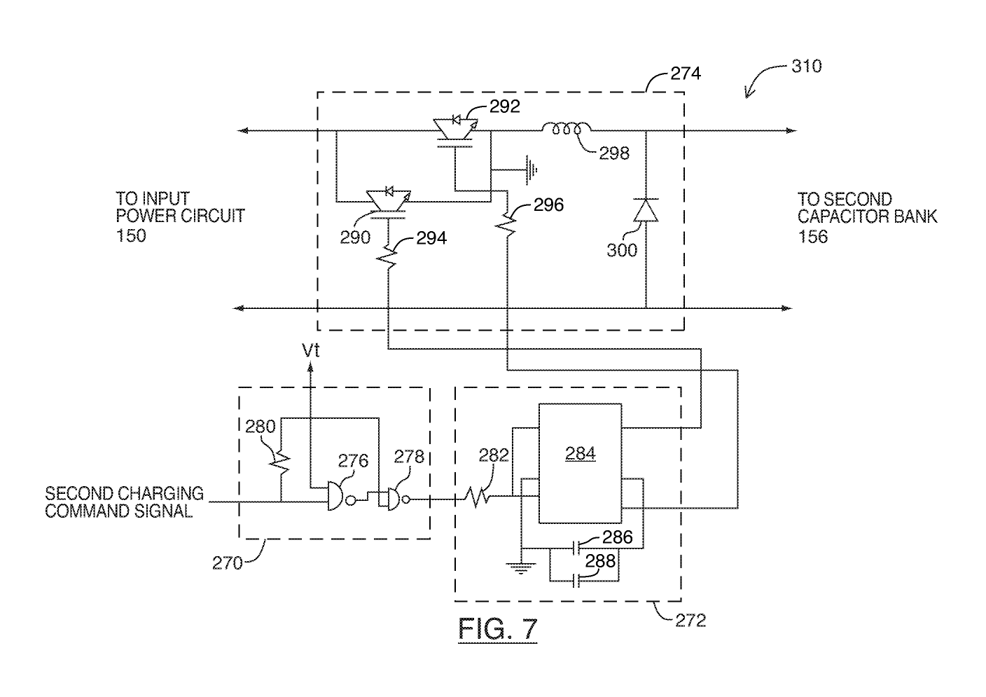

FIG. 7 shows second charging circuitry 158 of FIG. 3. As described above, second charging circuitry 158 receives DC power from input power circuit 150 and charges second charge source 156 to establish a second voltage potential on second charge source 156. Second charging circuitry 158, similar to first charging circuitry 154, may include a level shifter circuit 270, a gate driver circuit 272, and a current supply circuit 274.

Level shifter circuit 270 receives the second charging command signal from main control circuit 162 and converts it to an appropriate level for gate driver circuit 272. Level shifter circuit 270 may include two NOR gates 276 and 278 connected in series and a resistor 280 connected to the first input of first NOR gate 276. NOR gates 276 and 278 may be 4093N NOR gates.

Gate driver circuit 272 receives the control signal from level shifter circuit 270 and provides sufficient current to drive current supply circuit 274. Gate driver circuit 272 may include a resistor 282, a gate driver integrated circuit (IC) chip 284 and two capacitors 286 and 288. Gate driver IC chip 284 may be a TC1234 dedicated MOSFET/IGBT gate driver.

Current supply circuit 274 receives DC power from input power circuit 150 and, when enabled, produces a charging current from the DC power. The charging current is then used to charge second charge source 156 to establish a second voltage potential on second charge source 156. Current supply circuit 274 is enabled by gate driver circuit 272. Current supply circuit 274 may include two transistors 290 and 292, two resistors 294 and 528, one diode 530, and an inductor 532. Transistors 290 and 292 are connected in parallel to provide a sufficient charging current to second charge source 156. Transistors 290 and 292 may be insulated gate bipolar transistors (IGBT) on FGA180N30 chips, and diode 530 may be an RURG3440 ultra-fast soft-recovery diode.

Discharge Circuitry

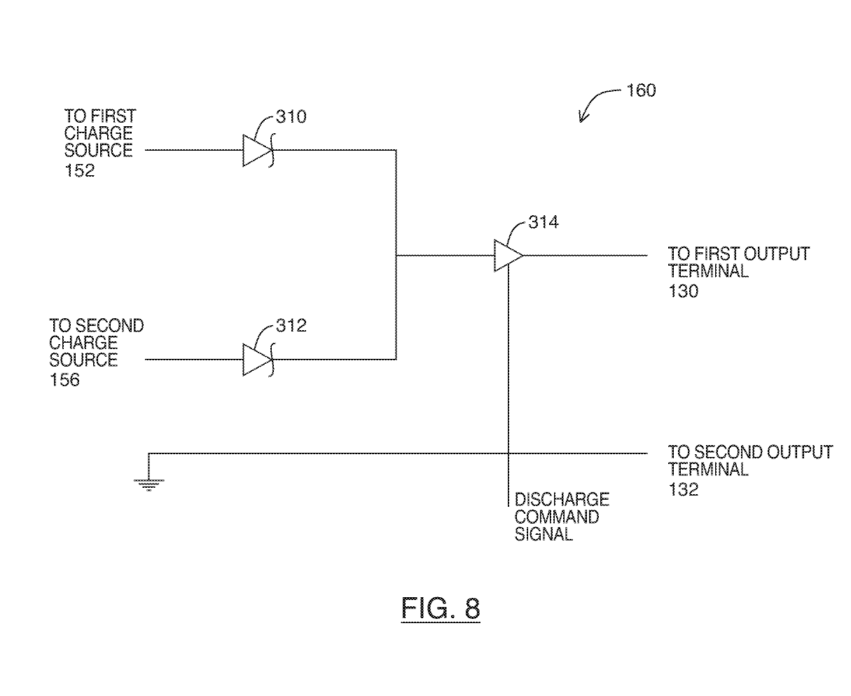

FIG. 8 shows discharge circuitry 160 of FIG. 3. As described above, discharge circuitry 160 is used to connect first and second charge sources 152 and 156 to first and second output terminals 130 and 132 for discharging during the ESD process. Discharge circuitry 160 may include two isolation elements 310 and 312 and a switching element 314. Isolation elements 310 and 312 are in series with first and second charge sources 152 and 156 respectively to bring first and second charge sources 152 and 156 together. In one embodiment, isolation elements 310 and 312 are connected to the positive terminals of first and second charge sources 152 and 156. Isolation elements 310 and 312 also isolate first and second charge sources 152 and 156 to ensure that charge will not be transferred between the charge sources. Isolation elements 310 and 312 are typically switching diodes, such as 150EBU02 ultra-fast switching diodes.

Switching element 314 is situated between first and second charge sources 152 and 156 and first and second output terminals 130 and 132. When switching element 314 is enabled, first and second charge sources 152 and 156 are connected to first and second output terminals 130 and 132 and can be discharged during the ESD process. Conversely, when switching element 314 is disabled, first and second charge sources 152 and 156 are not connected to first and second output terminals 130 and 132 and thus cannot be discharged. Switching element 314 may be controlled by the discharge command signal generated by main control circuit 162. As described above, the discharge command signal may be enabled by main control circuit 162 only after main control circuit 162 has determined that first and second charge sources 152 and 156 have been charged to the first and second charging threshold voltage potentials V_{1c} and V_{2C} respectively. Switching element 314 may be a high current thyristor module, such as the MCC95-io1b thyristor module.

Main Control Circuit

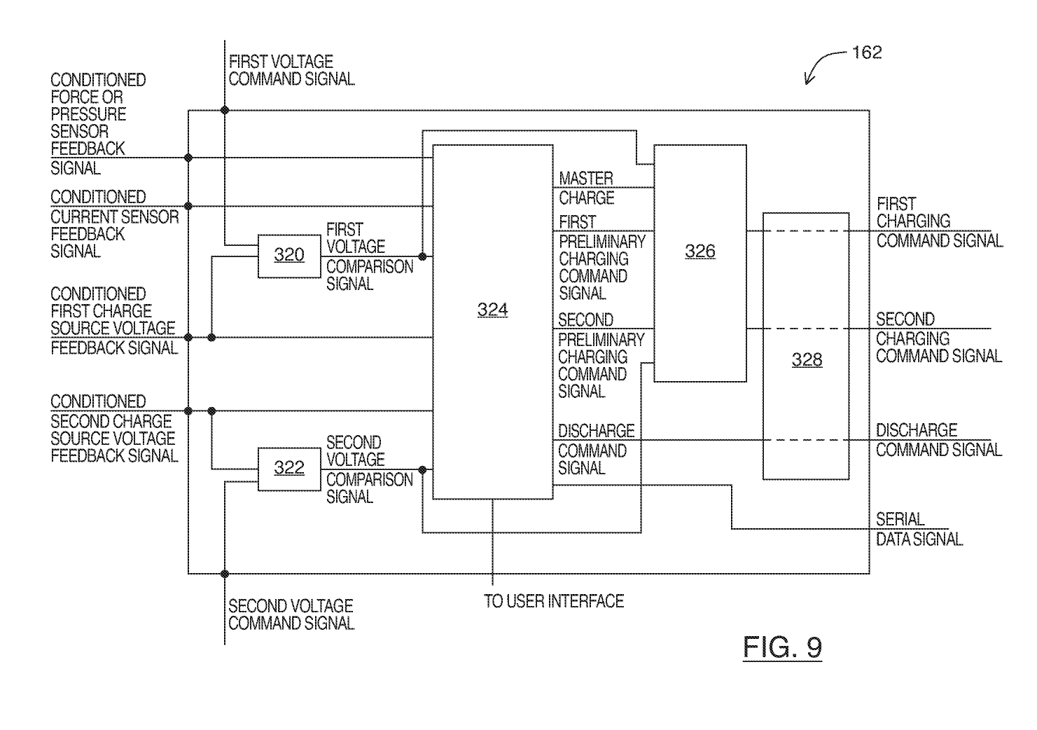

FIG. 9 shows main control circuit 162 of FIG. 3. Main control circuit 162 may include a first voltage comparator circuit 320, a second voltage comparator circuit 322, a main processor 324, a charging control circuit 326, and a digital output isolation circuit 328.

First voltage comparator circuit 320 determines whether first charge source 152 has been charged to the first charging threshold voltage potential V_{1C}. For example, first voltage comparator circuit 320 may receive as inputs the first charge source voltage feedback signal and the first voltage command signal, compare the input signals, and output a first voltage comparison signal. The first voltage comparison signal may be used to indicate when the first charge source voltage feedback signal is equal to or greater than the first voltage command signal. For example, the first voltage comparison signal may be logic high when the first charge source voltage feedback signal is equal to or greater than the first voltage command signal, and logic low otherwise.

Second voltage comparator circuit 322 determines whether second charge source 156 has been charged to the second charging threshold voltage potential. For example, second voltage comparator circuit 322 may receive as inputs the second charge source voltage feedback signal and the second voltage command signal, compare the input signals, and output a second voltage comparison signal. The second voltage comparison signal may be used to indicate when the second charge source voltage feedback signal is equal to or greater than the second voltage command signal. For example, the second voltage comparison signal may be logic high when the second charge source voltage feedback signal is equal to or greater than the second voltage command signal, and logic low otherwise.

Main processor 324 receives one or more input signals and generates one or more output signals based on the status of the one or more input signals. Main processor 324 may be a standard microprocessor, such as Microchip' s™ PIC™ 16F886. In one embodiment, main processor 324 receives the following input signals: the conditioned force or pressure feedback signal from first input signal conditioning circuit 164; the conditioned current sensor feedback signal from second input conditioning circuit 166; the conditioned first charge source voltage feedback signal from third input signal conditioning circuit 168; the conditioned second charge source voltage feedback signal from fourth input signal conditioning circuit 170; the first voltage comparison signal from first voltage comparator 320; and the second voltage comparison signal from second voltage comparator 322. Based on these input signals, main processor 324 may generate the following output signals: a master charging command signal; a first preliminary charging command signal; a second preliminary charging command signal; a discharge command signal; and a serial data signal.

The master charging control signal is used to enable charging of first and second charge sources 152 and 156. In some embodiments, the master charging control signal is only enabled after main processor 324 determines that the ESD process is complete. Main processor 324 may determine that the ESD process is complete when at least one of the first and second voltage potentials of first and second charge sources 152 and 156 respectively, drop below a discharge threshold level V_{L}. For example, main processor 328 may monitor the first and second charge source voltage feedback signals and enable the master charge control signal only after both signals drop to zero or substantially zero. Other suitable methods of determining the completion of the ESD process may also be used.

The first preliminary charging command signal is a preliminary version of the first charging control signal that controls first charging circuitry 154 and thus the charging of first charge source 152. The first preliminary charging command signal is typically sent to charging control circuit 326 where it is used to generate the first charging command signal.

In some embodiments, the first preliminary charge command signal is a pulse-width modulation (PWM) signal. The pulse width of the signal determines the magnitude of the charging current to be delivered to first charge source 152. The duty cycle of the first PWM signal may be fixed or may be adjustable. For example, user interface 174 may allow the user to set the duty cycle for the first PWM signal. In one embodiment, the operator may set the duty cycle to any value from 0 to 100%. The default value may be, for example, 50%. Preferably the duty cycle of the first PWM signal can only be adjusted by an administrator or technician.

The second preliminary charging command signal is a preliminary version of the second charging control signal that controls second charging circuitry 158 and thus the charging of second charge source 156. The second preliminary charging command signal is typically sent to charging control circuit 326 where it is used to generate the second charging command signal.

In some embodiments, the second preliminary charging command signal is a PWM signal. The pulse width of the signal determines the magnitude of the charging current to be delivered to second charge source 156. The duty cycle of the second PWM signal may be fixed or may be adjustable. For example, user interface 174 may allow the operator to set the duty cycle for the second PWM signal. In one embodiment, the user can set the duty cycle to any value from 0 to 100%. The default value may be set to, for example, 50%. Preferably the duty cycle of the second PWM signal can only be adjusted by an administrator or technician.

The discharge command signal enables discharge circuitry 160 and thus allows discharging of first and second charge sources 152 and 156. Until the discharge command signal is enabled, first and second charge sources 152 and 156 cannot typically be discharged. In some embodiments, the discharge command is only enabled after main processor 324 has determined that first and second charge sources 152 and 156 have been charged to the first and second charging threshold voltage potentials V_{1C} and V_{2C} respectively. Main processor 328 may, for example, monitor the first and second voltage comparison signals and determine that first and second charge sources 152 and 156 have been charged to the first and second charging threshold voltage potentials V_{1C} and V_{2C} when the first and second voltage comparison signals are logic level high.

In other embodiments, a second condition must also be met before the discharge command is enabled. For example, the discharge command may not be enabled unless a predetermined time has elapsed since the previous discharge. This time will be referred to as the discharge delay. The discharge delay may be fixed or user adjustable. For example, user interface 174 may allow the operator to set the discharge delay. In one embodiment, the user may set the discharge delay parameter to any value between 0 and 50 with a default value of 5. Main processor 324 may calculate the discharge delay time by multiplying the discharge delay parameter entered by the user by a time constant (e.g. 0.5 ms). Preferably the discharge delay can only be adjusted by an administrator or technician.

In some embodiments, the system may include an input port 140 for receiving a discharge command signal generated by an external device or interface. The external discharge command signal would allow external control of the discharge of first and second charge sources 152 and 156. Typically, the external discharge command signal is connected in parallel with the internal discharge command signal so that discharge of first and second charge sources 152 and 156 can be enabled by either discharge command signal.

The serial data signal may be a combination of, or may contain the information to generate the following analog output signals: the first voltage command signal, the second voltage command signal, the motor speed command signal, and the force or pressure command signal. Typically the serial data signal is sent to output signal conditioning unit 172 which generates the individual analog output signals from the serial data signal.

As described above, the first and second voltage command signals represent the first and second charging threshold voltage potentials V_{1C} and V_{2C} respectively. Where the first and second charging threshold voltage potentials V_{1C} and V_{2C} are user adjustable, the first and second voltage command signals are typically generated by main control circuit 162 based on the information received from user interface 174. For example, where the operator inputs specific values for the first and second charging threshold voltage potentials to user interface 174, then these values may be communicated to main control circuit 162 via the communication link between the main control circuit 162 and user interface 174. If, however, the operator does not input specific values for the first and second charging threshold voltage potentials V_{1C} and V_{2C}, then the default values may be used. The default values may be communicated to main control circuit 162 from user interface 174 via the communications link, or, alternatively, the default values may be programmed into main control circuit 162.

The motor speed command signal is used to control the motor speed of one or both of the consumable deposition substance holder 134 motor and the workpiece holder 136 motor. The force or pressure command signal is used to control the pressure or force at which consumable deposition substance 122 is brought into contact with workpiece 124 when consumable deposition substance holder 134 is controlled by a machine rather than by an operator. The force or pressure command signal is designed to interface with a pressure actuator circuit of the machine. The motor speed command signal or the force or pressure command signal, or both, may be generated based on the force or pressure feedback signal (discussed below) or the information received from user interface 174, or both. For example, where the operator inputs specific values for the motor speed or the force or pressure, then these values may be communicated to main control circuit 162 via the communication link between the main control circuit 162 and user interface 174. If, however, the operator does not input specific values for the motor speed or force or pressure, then the default values may be used. The default values may be communicated to main control circuit 162 from user interface 174 via the communications link, or, alternatively, the default values may be programmed into main control circuit 162.

Charging control circuit 326 receives all of the charging signals and generates the first and second charging command signals based on the received charging signals. As described above, the first and second charging command signals control first and second charging circuitry 154 and 158 respectively. That is, the first and second charging command signals control the charging of first and second charge sources 152 and 156 respectively.

Charging control circuit 326 may receive the following signals as inputs: the first preliminary charging command signal generated by main processor 324; the second preliminary charging command signal generated by main processor 324; the master charging command signal generated by main processor 324; the first voltage comparison signal generated by first voltage comparator circuit 320; and the second voltage comparison signal generated by second voltage comparator circuit 322.

In some embodiments, charging control circuit 326 may output the first preliminary charging command signal (e.g. the first PWM signal) as the first charging command signal when the ESD process is complete (e.g. when the master charging command signal is logic high) and first charge source 152 has not been charged to the first voltage potential (e.g. when the first voltage comparison signal is logic low). In other cases, the first charging command signal may be set to a null value.

Similarly, charging control circuit 326 may output the second preliminary charging command signal (e.g. the second PWM signal) as the second charging command signal when the ESD process is complete (e.g. when the master charging command signal is logic high) and second charge source 156 has not been charged to the second voltage potential (e.g. when the second voltage comparison signal is logic low). In other cases, the second charging command signal may be set to a null value.

Digital output isolation circuit 328 isolates the digital outputs of main control circuit 162 from the other aspects of coating deposition apparatus 126. Digital output isolation circuit 328 may include an optical coupler for each digital output. In one embodiment, main control circuit 162 produces the following three digital outputs: the first charge command signal produced by charging control circuit 326; the second change command signal produced by charging control circuit 326; and the discharge command signal produced by main processor 324. In this embodiment, digital output isolation circuit 328 may include three optical couplers, one for each digital output signal.

Conditioning Circuits

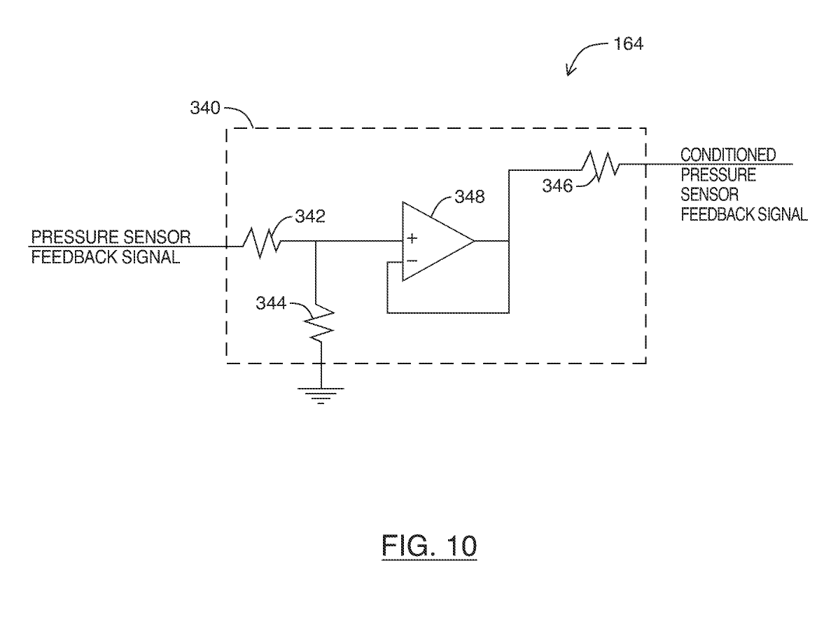

FIG. 10 shows first input conditioning circuit 164 of FIG. 3. As described above, first input conditioning circuit 164 converts the force or pressure sensor feedback signal into a signal suitable for processing by main control circuit 162. The output signal will be referred to as the conditioned force or pressure feedback signal. First input conditioning circuit 164 may include an amplification circuit 340 that reduces the amplitude of the pressure sensor feedback signal so that it falls within a predetermined range (e.g. 0 to 2.5 V). Amplification circuit 340 may include three resistors 342, 344, and 346, and an operational amplifier 348. Where, for example, the force or pressure sensor feedback signal has a range of 0V to 4.5V, a 0.5 amplification circuit would be sufficient to convert the pressure sensor feedback signal to a 0 to 2.25V signal. This level of amplification could be achieved, for example, by setting the resistance of first and second resistors 342 and 344 to 1 KΩ.

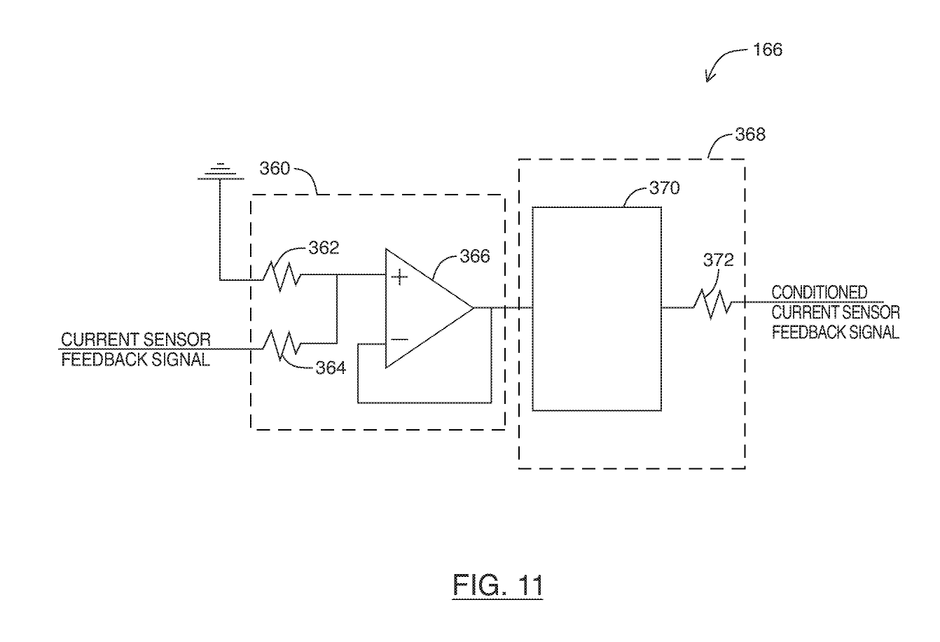

FIG. 11 shows second input conditioning circuit 166 of FIG. 3. As described above, second input conditioning circuit 166 converts the current sensor feedback signal into a signal suitable for processing by main control circuit 162. The output signal will be referred to as the conditioned current sensor feedback signal. Second input conditioning circuit 166 may include an amplification circuit 360 that reduces the amplitude of the current sensor feedback signal so that it falls within a predetermined range (e.g. 0 to 2.5 V). Amplification circuit 360 may include two resistors 362 and 364 and an operational amplifier 366. Where, for example, the current sensor feedback signal has a range of 0V to 4V, a 0.625 amplification circuit would be sufficient to convert the current sensor feedback signal to a 0 to 2.5V signal. This level of amplification could be achieved, for example, by setting the resistance of first resistor 362 to 1 KΩ and setting resistance of second resistor 364 to 0.6 KΩ.

Due to the short duration of the current pulses, second input conditioning circuit 166 may also include a voltage peak detect and hold circuit 368 to detect and hold the peak value of the current pulses for processing by the main control circuit 162. Voltage peak detect and hold circuit 368 may include a dedicated peak hold integrated circuit chip 370, such as the PKD01, and a resistor 372.

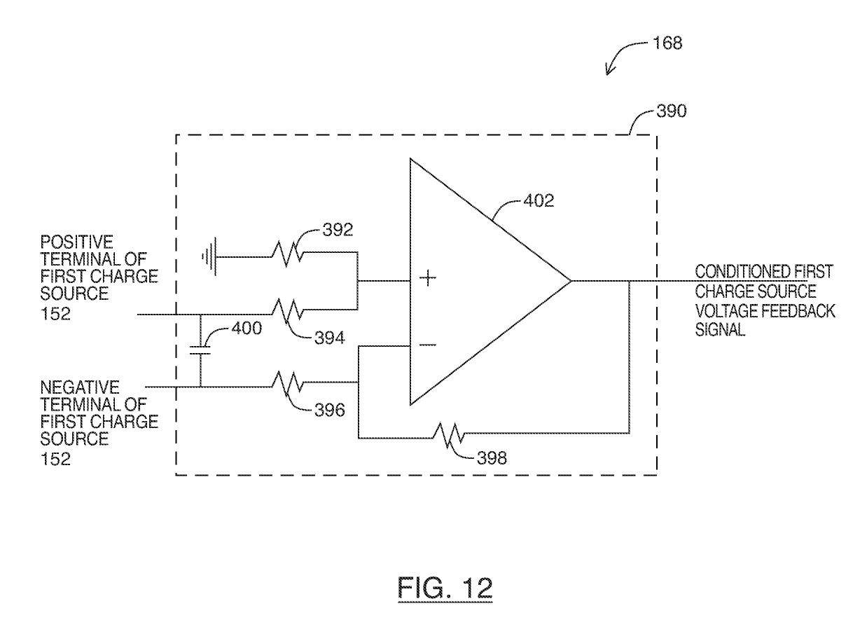

FIG. 12 shows third input conditioning circuit 168 of FIG. 3. As described above, third input conditioning circuit 168 converts the first charge source voltage feedback signal into a signal suitable for processing by main control circuit 162. The output signal will be referred to as the conditioned first charge source voltage feedback signal. Third input conditioning circuit 168 may include a differential circuit 390 that determines the difference between the two input points and amplifies the difference to produce the conditioned first charge source voltage feedback signal. The differential configuration helps to remove any common mode noise between main control circuit 162 and first charge source 152. The differential circuit 390 may include four resistors 392, 394, 396 and 398, a capacitor 400 and an operational amplifier 402 configured as a differential amplifier.

Where, for example, the first charge source voltage feedback has a range of 0V to 48.75 V, a gain of 0.05128 would be sufficient to convert the first charge source voltage feedback signal to a 0 to 2.5V signal. This level of amplification could be achieved, for example, by setting the resistance of first and fourth resistors 392 and 398 to 20 KΩ and setting resistance of second and third resistors 394 and 396 to 390 KΩ.

As described above, fourth input conditioning circuit 170 for conditioning the second charge source voltage feedback signal may be similar to, if not identical to, third input conditioning circuit 168.

Output Signal Conditioning Circuit

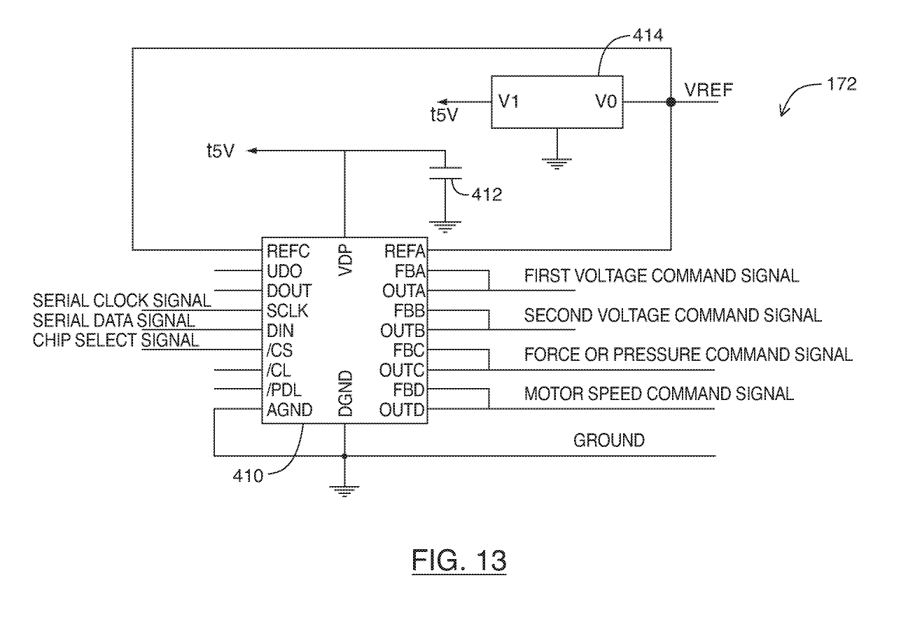

FIG. 13 shows output signal conditioning circuit 172 of FIG. 3. As described above, output signal conditioning circuit 172 receives the digital serial data signal from main control circuit 162 and generates the following analog output signals from the serial data signal: the first voltage command signal, the second voltage command signal, the pressure command signal and the motor speed command signal. Output signal condition circuit 172 may include a digital to analog conversion circuit 410, a voltage reference supply circuit 412 and a capacitor 414.

Digital to analog conversion circuit 410 receives the digital serial data signal from main control circuit 162, a clock signal from main control circuit 162, and a reference voltage from voltage reference supply circuit 412 and generates the four analog output signals. In some embodiments, voltage reference supply circuit 412 supplies a 2.5 V reference. This means that analog output signals will have a range of 0V to 2.5V. Where other formats or levels (e.g. 0-10V, or 4-20 mA) are required, output signal conditioning circuit 172 may also include converter or driver circuits. Alternatively, external converter or driver circuits may be used to achieve alternative formats or levels.

In one embodiment, digital to analog conversion circuit 410 is a MAX5250 four channel voltage-output 10-bit digital-to-analog converter chip, and voltage reference supply circuit 412 is an AD580 precision voltage reference chip.

Voltage Comparison Circuits

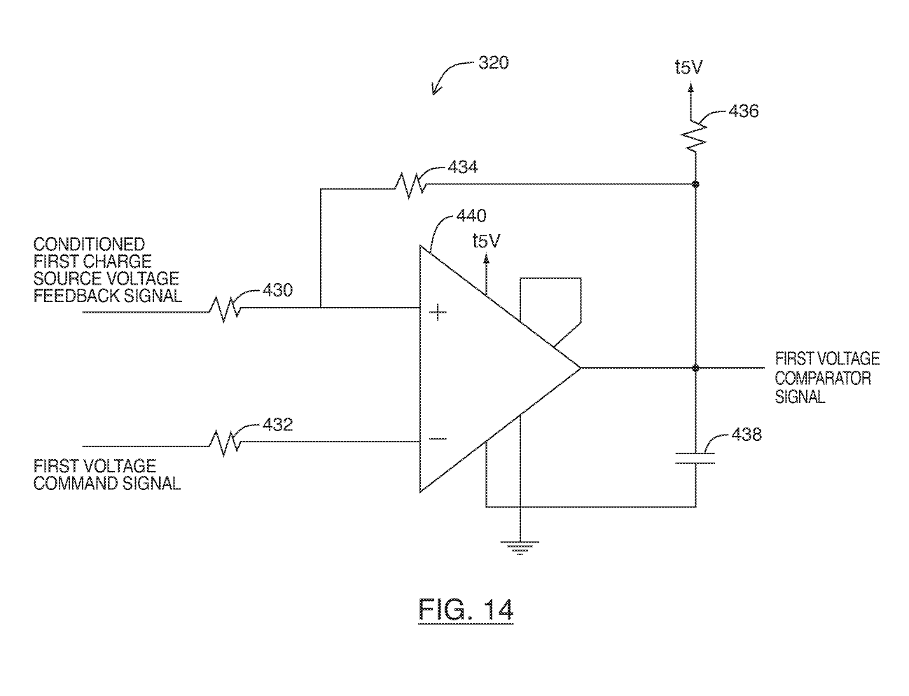

FIG. 14 shows first voltage comparator circuit 320 of FIG. 9. As described above, first voltage comparator circuit 320 determines whether first charge source 152 has been charged to the first charging threshold voltage potential V_{1C}. As shown in FIG. 14, first voltage comparator circuit 320 may have four resistors 430, 432, 434 and 436, one capacitor 438 and an operational amplifier 440 configured as a differential amplifier. First voltage comparator circuit 320 receives as inputs the conditioned first charge source voltage feedback signal and the first voltage command signal. As described above, the conditioned first charge source voltage feedback signal indicates the first voltage potential of first charge source 152, and the first voltage command signal indicates the first charging threshold voltage potential. First voltage comparator circuit 320 compares the two input signals and outputs a first voltage comparison signal that is logic high when the first charge source voltage feedback signal is greater than or equal to the first voltage command signal, and logic low otherwise. The first voltage comparison signal may then be passed to main processor 324 and charging control circuit 326 for further processing. Accordingly, the first voltage comparison signal is logic high when first charge source 152 has been charged to the desired level, and is logic low otherwise.

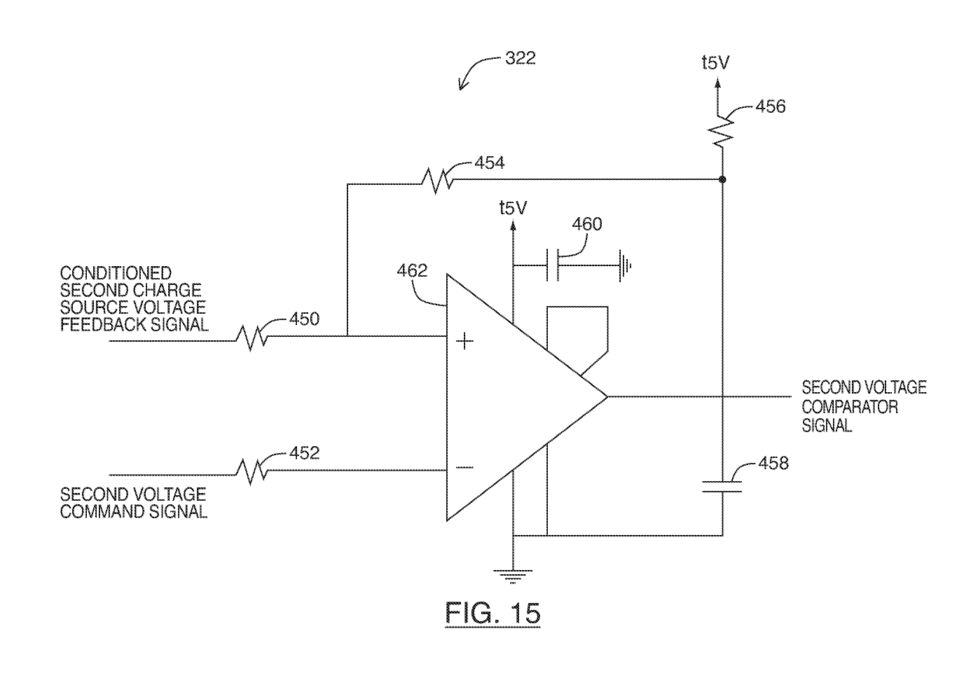

FIG. 15 shows second voltage comparator circuit 322 of FIG. 9. As described above, the second voltage comparator circuit 322 determines whether second charge source 156 has been charged to the second charging threshold voltage potential V_{2C}. As shown in FIG. 15, second voltage comparator circuit 322 may include four resistors 450, 452, 454 and 456, two capacitors 458 and 460 and an operational amplifier 462 configured as a differential amplifier. Second voltage comparator circuit 322 receives as inputs the conditioned second charge source voltage feedback signal, and the second voltage command signal. As described above, the conditioned second charge source voltage feedback signal indicates the second voltage potential of second charge source 156, and the second voltage command signal indicates the second charging threshold voltage potential. Second voltage comparator circuit 322 compares the two input signals and outputs a second voltage comparison signal that is logic high when the second charge source voltage feedback signal is greater than or equal to the second voltage command signal, and logic low otherwise. Accordingly, the second voltage comparison signal is logic high when second charge source 156 has been charged to the desired level, and is logic low otherwise.

Charging Control Circuit

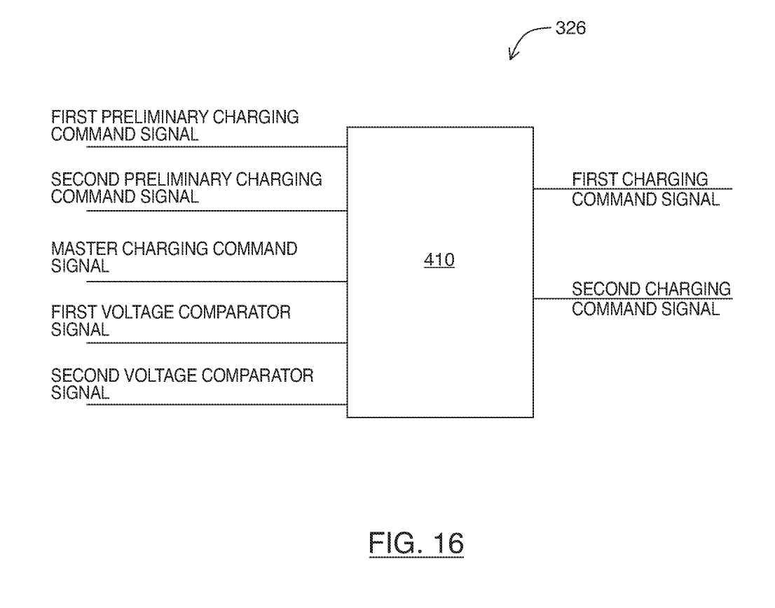

FIG. 16 shows charging control circuit 326 of FIG. 9. As described above, charging control circuit 326 receives all of the charging signals (e.g. the first preliminary charging command signal generated by main processor 324, the second preliminary charging command signal generated by main processor 324, the master charging command signal generated by main processor 324, the first voltage comparison signal generated by first voltage comparator circuit 320, and the second voltage comparison signal generated by second voltage comparator circuit 322) and generates the first and second charging command signals based on the received signals. The first and second charging command signals control first and second charging circuitry 154 and 158 respectively. That is, the first and second charging command signals control the charging of first and second charge sources 152 and 156 respectively. Charging control circuit 326 may include a programmable array logic circuit 470, such as a PAL16V8.

In some embodiments, programmable array logic circuit 470 may output the first preliminary charging command signal (e.g. the first PWM signal) as the first charging command signal when the ESD process is complete (e.g. when the master charging command signal is logic high) and first charge source 152 has not been charged to the first voltage potential (e.g. when the first voltage comparison signal is logic low). In other cases, the first charging command signal may be set to a null value.

Similarly, programmable array logic circuit 470 may output the second preliminary charging command signal (e.g. the second PWM signal) as the second charging command signal when the ESD process is complete (e.g. when the master charging command signal is logic high) and second charge source 156 has not been charged to the second voltage potential (e.g. when the second voltage comparison signal is logic low). In other cases, the second charging command signal may be set to a null value.

Digital Output Isolation Circuit

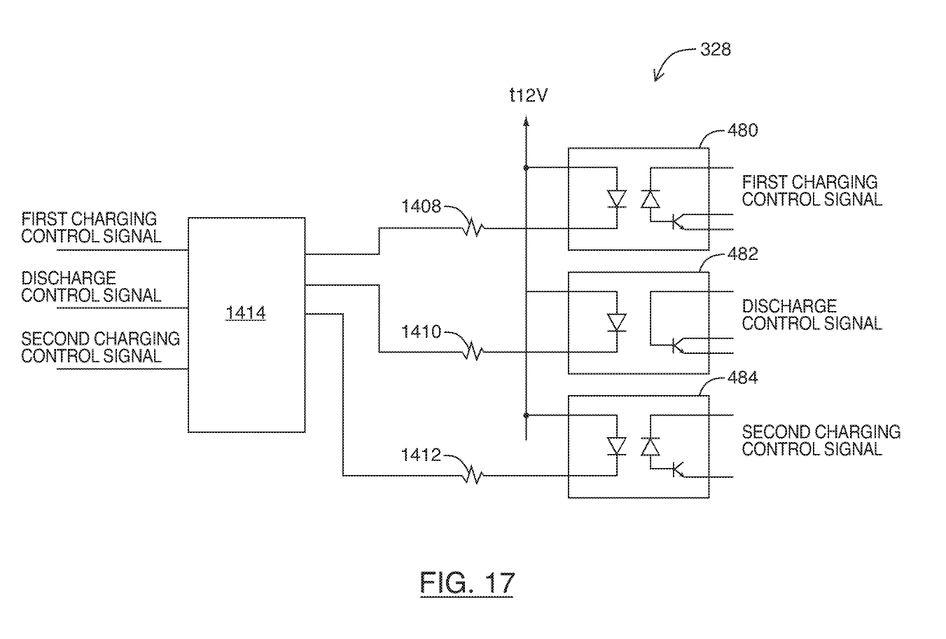

FIG. 17 shows digital output isolation circuit 328 of FIG. 9. As described above, digital output isolation circuit 328 isolates the digital outputs of main control circuit 162 from the other aspects of coating deposition apparatus 126. As shown in FIG. 17, digital output isolation circuit 328 may include three optical couplers 480, 482, and 484—one for each of the following three outputs—the first charging command signal produced by charging control circuit 326, the second charging command signal produced by charging control circuit 326, and the discharge command signal produced by main processor 324. The optical couplers associated with the charging command signals (e.g. first and third optical couplers 480 and 484) may be high-speed optical couplers, such as 6N135 high speed optical couplers. The optical coupler associated with the discharge command signal (e.g. second optical coupler 482) may be a standard optical coupler, such as a 4N33 optical coupler.

Digital output isolation circuit 328 may also include three resistors 486, 488, and 490 and a driving circuit 492 to control the current in optical couplers 480, 482 and 484.

Alternative Coating Deposition Apparatus

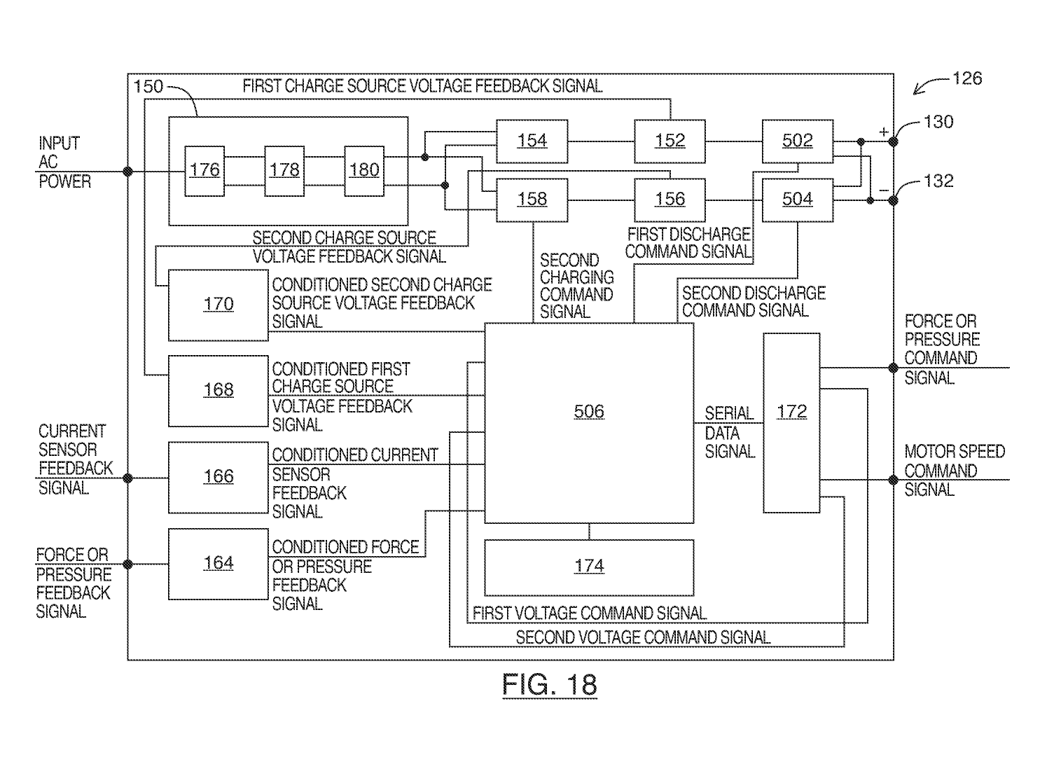

FIG. 18 shows an alternative coating deposition apparatus 500. Coating deposition apparatus 500, similar to coating deposition apparatus 126 of FIG. 3, may include an input power circuit 150, a first charge source 152, first charging circuitry 154, a second charge source 156, second charging circuitry 158, one or more input signal conditioning circuits 164, 166, 168 and 170, one or more output signal conditioning units 172, and a user interface 174. However, coating deposition apparatus 500 includes two discharge circuits 502 and 504 which are controlled by first and second discharge control signals, respectively, generated by main control circuit 506.

First discharge circuit 502 controls discharge of first charge source 152. When first discharge circuit 502 is enabled, first charge source 152 may be discharged and thus provide power to the ESD process. Conversely, when first discharge circuit 502 is disabled, first charge sources 152 is inhibited from being discharged, and thus no power may provided to the ESD process from first charge source 152.

First discharge circuit 502 is typically controlled by a first discharge command signal generated by main control circuit 506. In some embodiments, first discharge circuit 502 is disabled (and incidentally discharge of first charge source 152 is inhibited) until the main control circuit 162 detects that first charge source 152 has been charged to the first charging threshold voltage potential V_{1C}.

In one embodiment, first discharge circuit 502 includes a switching element connected in series with first charge source 152 and first and second output terminals 130 and 132. When the switching element is enabled, first charge source 152 is connected to first and second output terminals 130 and 132 and may provide power to the ESD process. When the switching element is disabled, there is a break in the circuit so that first charge source 152 is not connected to first and second output terminals 130 and 132 and thus may not provide power to the ESD process. The switching element is typically enabled and disabled by the first discharge command signal generated by main control circuit 506. The switching element is typically a thyristor, a power IGBT or a MOSFET, but the switching element may be any other suitable switching device.

Second discharge circuit 504 controls discharge of second charge source 156. When second discharge circuit 504 is enabled, second charge source 156 may be discharged and thus second charge source 156 may provide power to the ESD process. Conversely, when second discharge circuit 504 is disabled, second charge source 156 is inhibited from being discharged, thus second charge source 156 may not provide power to the ESD process.

Second discharge circuit 504 is typically controlled by a second discharge command signal generated by main control circuit 506. In some embodiments, second discharge circuit 504 is disabled (and incidentally discharge of second charge source 156 is inhibited) until (i) the main control circuit 506 detects that second charge source 156 has been charged to the second charging threshold voltage potential V_{2C}; and (ii) discharge of first charge source 152 has commenced. These conditions are implemented to ensure that second charge source 156 has reached the second charging threshold voltage potential V_{2C} prior to being discharged, and second charge source 156 cannot be discharged until the second or arcing phase of the ESD process. This may give the operator better control over the ESD process.

In one embodiment, second discharge circuit 504 includes a switching element connected in series with second charge source 156 and first and second output terminals 130 and 132. When the switching element is enabled, second charge source 156 is connected to first and second output terminals 130 and 132 and may provide power to the ESD process. When the switching element is disabled, there is a break in the circuit so that second charge source 156 is not connected to first and second output terminals 130 and 132 and thus may not provide power to the ESD process. The switching element is typically enabled and disabled by the second discharge command signal generated by main control circuit 506. The switching element is typically a power IGBT or a MOSFET, but may be another other suitable switching device.

Main control circuit 506 is identical to main control circuit 162 of FIG. 3 except that it also generates the first and second discharge control signals in accordance with the above description.

The principles of the present invention are not limited to these specific examples which are given by way of illustration. It is possible to make other embodiments that employ the principles of the invention and that fall within its spirit and scope of the invention. Since changes in or additions to the above-described embodiments may be made without departing from the nature, spirit or scope of the invention, the invention is not to be limited to those details.

What is claimed is:

1. A coating deposition apparatus comprising:
first and second charge sources;
said first charge source being chargeable to a first voltage potential;
said second charge source being chargeable to a second voltage potential;
a first output terminal and a consumable deposition substance connected thereto;
a second output terminal for connection to a workpiece;
said consumable deposition substance being movable relative to said workpiece;
said first charge source being connected between said first and second terminals whereby said first voltage potential is established therebetween;
said second charge source being connected between said terminals; and
discharge control circuitry connected to said first and second charge sources to inhibit discharge of said second charge source through said terminals prior to commencement of discharge of said first charge source through said terminals.

2. The coating deposition apparatus of claim 1, wherein said discharge control circuitry includes at least one isolation element operable to prevent charge from flowing from said first charge source to said second charge source.

3. The coating deposition apparatus of claim 1, wherein said apparatus includes:
charging circuitry by which to charge said first and second charge sources; and
said discharge control circuitry is operable to inhibit discharge of at least one of said first and second charge sources during charging thereof.

4. The coating deposition apparatus of claim 3, wherein said apparatus includes voltage potential monitoring circuitry connected to sense voltage potential across said first charge source and across said second charge source, and said discharge control circuitry is operable to inhibit discharge of said first and second charge sources until said first charge source reaches at least a first charging threshold voltage potential and said second charge source reaches at least a second threshold voltage potential.

5. The coating deposition apparatus of claim 1, wherein at least one of said first and second charge sources is one of a) a capacitor; and b) a capacitor bank.

6. The coating deposition apparatus of claim 5, wherein at least one of said first and second charge sources has a variable capacitance.

7. The coating deposition apparatus of claim 1, wherein said consumable deposition substance is composed at least in part of titanium, titanium carbide, titanium diboride, nickel, molybdenum, and tungsten.

8. The coating deposition apparatus of claim 7, wherein said consumable deposition substance is predominantly titanium.

9. The coating deposition apparatus of claim 7, and including the workpiece wherein said workpiece is predominantly copper.

10. The coating deposition apparatus of claim 1, wherein said apparatus includes a vibrator mounted to act on at least one of (a) said workpiece; and (b) said consumable deposition substance.

11. The coating deposition apparatus of claim 1, wherein said apparatus includes a drive to spin at least one of (a) said workpiece; and (b) said consumable deposition substance, to present a different portion of said workpiece to said consumable deposition substance as a function of time.

12. A process of depositing a coating on an electrically conductive workpiece, using a coating deposition apparatus, the coating deposition apparatus having first and second charge sources coupled between first and second output terminals, said process comprising:
connecting a consumable deposition substance of coating material to said first terminal;
connecting a workpiece to said second terminal;
establishing a first voltage potential on said first charge source;
establishing a second voltage potential on said second charge source;
establishing said consumable deposition substance and said workpiece in close proximity;
discharging charge from said first charge source between said consumable deposition substance and said workpiece, thereby melting some of said consumable deposition substance and depositing it on said workpiece; and
after commencement of discharge of said first charge source, discharging charge from said second charge source between said consumable deposition substance and said workpiece, during arcing of current between said consumable deposition substance and said workpiece, thereby melting more of said consumable deposition substance and welding said melted consumable deposition substance to said workpiece.

13. The process of claim 12, wherein said process includes monitoring said first voltage potential, and commencing discharge of said second charge source when said first voltage potential falls below a first threshold value.

14. The process of claim 12, wherein said process includes recharging said first and second charge sources following respective discharge thereof, said process including inhibiting said recharging of at least said first charge source until said first voltage potential falls below a discharge threshold value.

15. The process of claim 14, wherein said process includes re-charging said first and second charge sources, and during said re-charging, inhibiting discharge of said first and second charge sources.

16. The process of claim 15, wherein said first charge source has a first charging threshold voltage potential, said second charge source has a second charging threshold voltage potential, and during re-charging, inhibiting discharge until said first charge source reaches at least said first charging threshold voltage potential and said second charge source reaches at least said second charging threshold voltage potential.

17. The process of claim 15, wherein:
said first charging source provides a first total energy to the output terminals during discharge thereof;
said second charging source provides a second total energy to the output terminals during discharge thereof;
said first total energy being related to said first charging threshold voltage potential;
said second total energy being related to said second charging threshold voltage potential;
at least one of said first and second charging threshold voltage potentials is adjustable; and
said process includes adjusting said at least one charging threshold voltage potential.

18. The process of claim 17, wherein:
said first charge source is associated with a first capacitance and said second charge source is associated with a second capacitance;
said first total energy is related to said first capacitance;
said second total energy is related to said second capacitance;
at least one of said first and second capacitances is adjustable; and
said process includes adjusting said at least one capacitance.

19. The process of claim 14, wherein said process includes waiting for a predetermined period of time following discharge; and inhibiting discharge during said predetermined period of time.

20. The process of claim 12, wherein said process includes selecting said consumable deposition substance from amongst substances that are at least partially one of titanium, titanium carbide, titanium diboride, nickel, molybdenum, and tungsten.

21. The process of claim 20, wherein said process includes selecting a substantially titanium substance as said consumable deposition substance.

22. The process of claim 20, wherein said process includes selecting a copper substance as said workpiece.

23. The process of claim 12, wherein said process includes vibrating at least one of said consumable deposition substance and said workpiece.

24. The process of claim 12, wherein said process includes rotating at least one of said workpiece and said consumable deposition substance to present a different portion of said workpiece to said consumable deposition substance as a function of time.
